(19) United States
(12) Patent Application Publication
(10) Pub. No.: US 2017/0032169 A1
(43) Pub. Date: Feb. 2, 2017

(54) SWIPE MOTION REGISTRATION ON A FINGERPRINT SENSOR

(71) Applicant: SHENZHEN HUIDING TECHNOLOGY CO., LTD., Guangdong (CN)

(72) Inventors: Bo PI, Shenzhen (CN); Yi HE, Shenzhen (CN)

(73) Assignee: Shenzhen Huiding Technology Co., Ltd.

(21) Appl. No.: 15/292,109

(22) Filed: Oct. 12, 2016

Related U.S. Application Data
(63) Continuation of application No. PCT/US2015/043048, filed on Jul. 31, 2015.
(60) Provisional application No. 62/046,934, filed on Sep. 6, 2014.

(51) Int. Cl. G06K 9/00; G06T 7/00

(52) U.S. Cl. CPC G06K 9/00013; G06K 9/00087; G06T 7/0026; G06K 9/00912

(57) ABSTRACT

In one aspect, a method for registering a fingerprint profile on a mobile device includes detecting, at a fingerprint detection module having a rectangular shape, a contact from a finger associated with a swipe motion. The method includes responsive to the detected contact at the fingerprint detection module having a rectangular shape, capturing an image of the finger during the swipe motion. The method includes storing the image of the finger captured during the swipe motion as a registered fingerprint profile of an authorized user.

### CROSS REFERENCE TO RELATED APPLICATIONS

The present application is a continuation of international application No. PCT/US2015/043048, filed on Jul. 31, 2015, which claims priority to U.S. Provisional Patent Application No. 62/046,934, filed on Sep. 6, 2014, both of which are hereby incorporated by reference in its entireties.

### TECHNICAL FIELD

The present disclosure generally relates to fingerprint recognition for securely accessing a mobile device.

### BACKGROUND

Electronic devices including portable or mobile computing devices, such as laptops, tablets, smartphones, and gaming systems may employ user authentication mechanisms to protect personal data and prevent unauthorized access. User authentication on an electronic device may be carried out through one or multiple forms of biometric identifiers, which can be used alone or in addition to conventional password authentication methods. A popular form of biometric identifiers is a person's fingerprint pattern. A fingerprint sensor can be built into the electronic device to read a user's fingerprint pattern so that the device can only be unlocked by an authorized user of the device through authentication of the authorized user's fingerprint pattern.

### SUMMARY

Embodiments described in this document provide devices, systems, and techniques that perform human fingerprint detection and authentication for authenticating an access attempt to a locked mobile device equipped with a fingerprint detection module.

In one aspect, a method for registering and recognizing a fingerprint profile on a mobile device is disclosed. The method includes operating in a fingerprint registration mode. Operating in the fingerprint registration module includes detecting, at a fingerprint detection module having a non-uniform shape, a contact from a finger associated with a swipe motion. Operating in the fingerprint registration module includes responsive to the detected contact at the fingerprint detection module having the non-uniform shape, capturing an image of the finger during the swipe motion. Operating in the fingerprint registration module includes storing the image of the finger captured during the swipe motion as a registered fingerprint profile of an authorized user. The method includes operating in a fingerprint recognition mode. Operating in the fingerprint recognition mode includes detecting a non-swipe contact from a finger of a user on the non-uniformly shaped fingerprint detection module of the mobile device while the mobile device is locked. Operating in the fingerprint recognition mode includes responsive to detecting the non-swipe contact, activating the non-uniformly shaped fingerprint detection module to capture a partial image of the finger making the non-swipe contact with the non-uniformly shaped fingerprint detection module. Operating in the fingerprint recognition mode includes comparing the captured partial image of the finger making contact with the non-uniformly shaped fingerprint detection module with the registered fingerprint profile of the authorized user of the mobile device. Operating in the fingerprint recognition mode includes responsive to the comparing, identifying the captured partial image as belonging to the authorized user and granting the user access to the locked mobile device.

The method can be implemented in various ways to includes one or more of the following features. The method can include receiving a signal indicating a fingerprint registration mode. The method can include responsive to receiving the signal indicating a fingerprint registration mode, activating the fingerprint detection module to capture the image of the finger. Capturing an image of the finger during the swipe motion can include capturing partial images of the finger in sequence during the swipe motion to accumulate a substantially complete fingerprint image to store as the registered fingerprint profile of an authorized user. Capturing an image of the finger during the swipe motion can include detecting differences between three lines of pixelated sensing elements of the rectangular shaped fingerprint detector module. The method can include analyzing the partial image of the finger captured during the swipe motion to determine whether a sufficient portion of the finger was captured to qualify as the registered fingerprint profile of an authorized user. The method can include outputting a message to instruct a user to swipe a finger across the non-uniformly shaped fingerprint detection module. The message can include at least one of audio, texts, images or videos. Comparing can include correlating the captured image of the finger with the registered fingerprint profile of an authorized user. Identifying can include when a correlation between the captured image of the finger and the registered fingerprint profile of an authorized user is statistically significant, identifying the captured image of the finger as bellowing to the authorized user. The non-uniformly shaped fingerprint detection module can include a rectangular shaped fingerprint detection module with a first number of sensor pixels in one dimension and a second number of sensing electrodes larger than the first number in another dimension. The method can include receiving a signal indicating the fingerprint recognition mode; and responsive to receiving the signal indicating the fingerprint recognition mode, activating the fingerprint detection module to operate in the fingerprint recognition mode.

In another aspect, a mobile device includes a transparent top cover. The mobile device includes a touch panel configured to receive touch input, the touch panel disposed under the transparent top cover. The mobile device includes a non-uniformly shaped fingerprint detection module to operate in a fingerprint registration mode to detect a swipe motion contact and a fingerprint recognition mode to detect a non-swipe motion contact. During the fingerprint registration mode, the non-uniformly shaped fingerprint detection module is configured to detect a contact from a finger associated with a swipe motion, responsive to the detected swipe motion contact, capturing an image of the finger, and store the image of the finger captured during the swipe motion as a registered fingerprint profile of an authorized user. During the fingerprint recognition mode, the non-uniformly shaped fingerprint detection module is configured to: detect a non-swipe contact from a finger of a user while the mobile device is locked, responsive to the detected non-swipe contact, activate the non-uniformly shaped fingerprint detection module to capture a partial image of the finger making the non-swipe contact with the non-uniformly shaped fingerprint detection module, compare the captured partial image of the finger making contact with the non-uniformly shaped fingerprint detection module with the registered fingerprint profile of the authorized user of the mobile device, and identify the captured partial image as belonging to the authorized user and granting the user access to the locked mobile device.

The mobile device can be implemented in various ways to include one or more of the following features. The rectangular shaped fingerprint detection module can be embedded in the transparent top cover to expose a top surface of the non-uniformly shaped fingerprint detection module to make direct contact with the finger of a user. The non-uniformly shaped fingerprint detection module can include a rectangular shaped fingerprint detection module with a first number of sensor pixels in one dimension and a second number of sensing electrodes larger than the first number in another dimension. The mobile device can include a protective cover disposed over the transparent top cover, the touch panel and the non-uniformly shaped fingerprint detection module to prevent direct contact between the finger of the user and the non-uniformly shaped fingerprint detection module. The non-uniformly shaped fingerprint detection module can include fingerprint sensing circuitry; and an array of sensing electrodes to detect the contact from the finger of the user to activate the non-uniformly shaped fingerprint detection module to capture the image of the finger of the user. The sensing circuitry can include more columns of pixelated sensing elements than rows of pixelated sensing elements. The non-uniformly shaped fingerprint detection module can receive a signal indicating the fingerprint registration mode. The non-uniformly shaped fingerprint module can capture the image of the finger during the swipe motion by capturing partial images of the finger in sequence during the swipe motion to accumulate a substantially complete fingerprint image to store as the registered fingerprint profile of an authorized user. The non-uniformly shaped fingerprint module can analyze the partial images of the finger captured during the swipe motion to determine whether a sufficient portion of the finger was captured to qualify as the registered fingerprint profile of an authorized user.

Various examples of fingerprint detection modules and fingerprint sensor modules described in this patent document can be integrated with mobile devices (e.g., smartphones, tablets, laptops), computing devices (e.g., personal computers), and other electronic devices to perform fingerprint authentication processes on these devices.

### BRIEF DESCRIPTION OF THE DRAWINGS

FIG. 1A shows an exemplary schematic of a cross-sectional view of an exemplary fingerprint detection module in accordance with some embodiments described herein.

FIG. 1B shows a cross-sectional view schematic of an exemplary reduced size fingerprint detection module shaped in a strip.

FIG. 1C is a process flow diagram showing an exemplary process 140 for performing a fingerprint registration mode of a hybrid mode of operation.

FIG. 1D shows a process flow diagram of a process 160 for performing a fingerprint recognition mode of a hybrid mode of operation.

FIG. 2A shows a schematic of an exemplary fingerprint sensor detector chip in accordance with some embodiments described herein.

FIG. 2B shows a schematic of an exemplary reduced size fingerprint sensor detector chip shaped in a strip.

FIG. 3A shows a perspective and cross-sectional view of an exemplary fingerprint detection module which includes an optical sensing mechanism for determining if a detected object is human in accordance with some embodiments described herein.

FIG. 3B provides another perspective and cross-sectional view of the fingerprint detection module in FIG. 3A in accordance with some embodiments described herein.

FIG. 3C provides a perspective view of the entire fingerprint detection module in FIG. 3A in accordance with some embodiments described herein.

FIG. 3D shows a cross-sectional view of an exemplary fingerprint detection module shaped in a strip which includes an optical sensing mechanism for determining whether a detected object matches a fingerprint profile of an authorized user.

FIG. 3E shows a perspective view of an exemplary reduced size fingerprint detection module shaped in a strip.

FIG. 4A illustrates a concept of using an exemplary fingerprint detection module to detect and determine whether a detected object is human in accordance with some embodiments described herein.

FIG. 4B illustrates a concept of using an exemplary reduced size fingerprint detection module shaped in a strip to determine whether a detected object matches a registered fingerprint profile of an authorized user.

FIG. 5A shows a data plot of an exemplary normalized human skin reflectance (in %) as a function of wavelength of the light source in accordance with some embodiments described herein.

FIG. 5B shows a data plot of an exemplary human blood light absorption property (in extinction coefficient) as a function of the wavelength of the light source in accordance with some embodiments described herein.

FIG. 6A shows a schematic of a mobile device integrated with a touch panel and an exemplary fingerprint detection module in accordance with some embodiments described herein.

FIG. 6B shows a schematic of another mobile device integrated with a touch panel and an exemplary fingerprint detection module in accordance with some embodiments described herein.

FIG. 6C shows a schematic of a mobile device integrated with a touch panel and an exemplary reduced size fingerprint detection module shaped in a strip.

FIG. 6D shows a schematic of another mobile device integrated with a touch panel and an exemplary reduced size fingerprint detection module shaped in a strip.

FIG. 7A presents a flowchart illustrating a process of activating a fingerprint detection module in standby mode and using the fingerprint detection module to authenticate an access attempt to a locked mobile device in accordance with some embodiments described. herein.

FIG. 7B presents a flowchart illustrating a process of activating a fingerprint detection module in standby mode and using the fingerprint detection module to authenticate an access attempt to a locked mobile device in a highly secure mode in accordance with some embodiments described herein.

FIG. 8 presents a flowchart illustrating a process of using the fingerprint detection module to authenticate an access attempt to a locked mobile device through a highly secure procedure in accordance with some embodiments described herein.

FIG. 9A illustrates a fingerprint detection module as a variation of fingerprint detection module for detecting and determining if a detected object is human in accordance with some embodiments described herein

FIG. 9B illustrates an exemplary fingerprint detection module which includes a protective cover coated with a colored layer in accordance with some embodiments described herein.

FIG. 9C illustrates an exemplary reduced size fingerprint detection module shaped in a strip for determining whether a detected object matches a registered fingerprint profile of an authorized user.

FIG. 9D illustrates a fingerprint detection module which includes a protective cover coated with a colored layer in accordance with some embodiments described herein.

FIG. 10 presents a diagram of a fingerprint detection system for performing human fingerprint detection and authentication in accordance with some embodiments described herein.

### DETAILED DESCRIPTION

Electronic devices equipped with fingerprint authentication mechanisms may be hacked by malicious individuals who can obtain the authorized user's fingerprint, and copy the stolen fingerprint pattern on a carrier object that resembles a human finger, which can then be used to unlock the targeted device. Hence, the fingerprint pattern, although a unique biometric identifier, may not be by itself a completely reliable or secure identification. The techniques, devices and systems described in this document improve upon the fingerprint authentication technology used in existing electronic devices to potentially prevent a stolen fingerprint from being used to gain access to the targeted device.

Embodiments described in this document provide devices, systems, and techniques that implement various fingerprint detection modules for human fingerprint detection and authentication. Moreover, embodiments described in this document provide devices, systems, and techniques that implement various fingerprint detection modules including an optical sensing unit to determine if a detected object is human. Specifically, the technology disclosed in this document uses an additional measurement obtained from a person to combine with the person's fingerprint pattern as a combination authentication method to identify whether the authorized person is accessing the device.

The disclosed technology uses probe light at two or more different probe light wavelengths where the human skin provides different optical responses at the two or more different wavelengths. Measurements of such optical responses at the two or more different wavelengths are used to combine with the positive identification of the person's fingerprint pattern to authenticate the access. This additional layer of authentication can improve the level of authentication and the security that may not be possible by using the fingerprint pattern alone. In the specific examples described below, the two or more different probe light wavelengths may be selected so that reflectance or absorption of the person's skins due to presence of the blood in the skin and the oxygen level in the blood to cause different optical responses in the reflected light or transmitted light at the selected two or more different wavelengths. In implementation, the device can include two sensor devices: (1) a fingerprint pattern recognition sensor and (2) an optical detection module for producing probe light of two or more different wavelengths and for measuring the reflectance or transmission of the probe light of the finger to measure the optical responses of the finger at the two or more different wavelengths. The measurements from the two sensor devices are combined to authenticate a person for accessing the device. In implementations, those two sensor devices can be integrated into a fingerprint ID module located on a surface of a device to enable a user to input the user's fingerprint when accessing the device. The appearance of such a fingerprint ID module may be similar to other fingerprint ID modules where only fingerprint patterns are detected and processed but the additional optical detection module based the measurements of probe light of two or more different wavelengths provides a unique added security and accuracy in granting proper user access to the device.

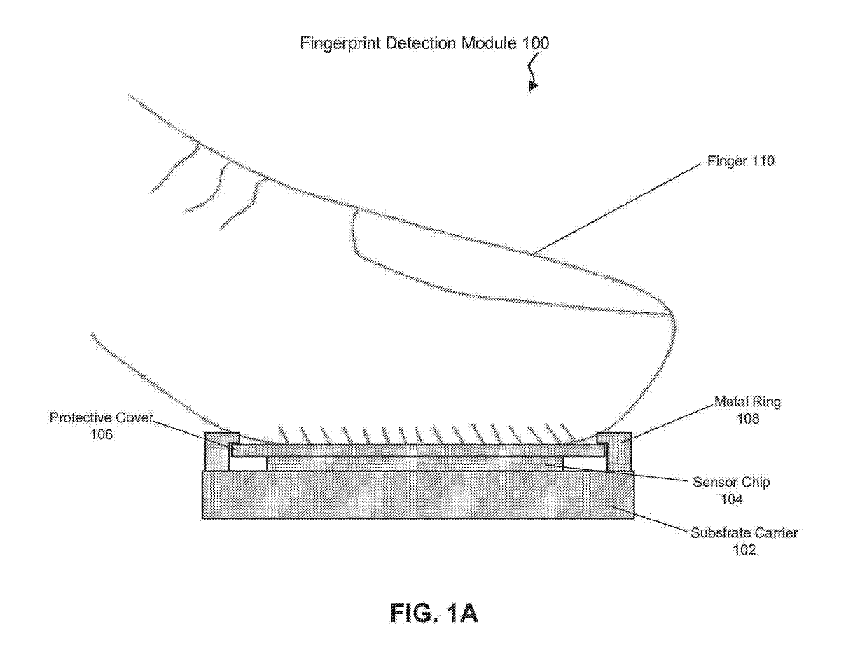

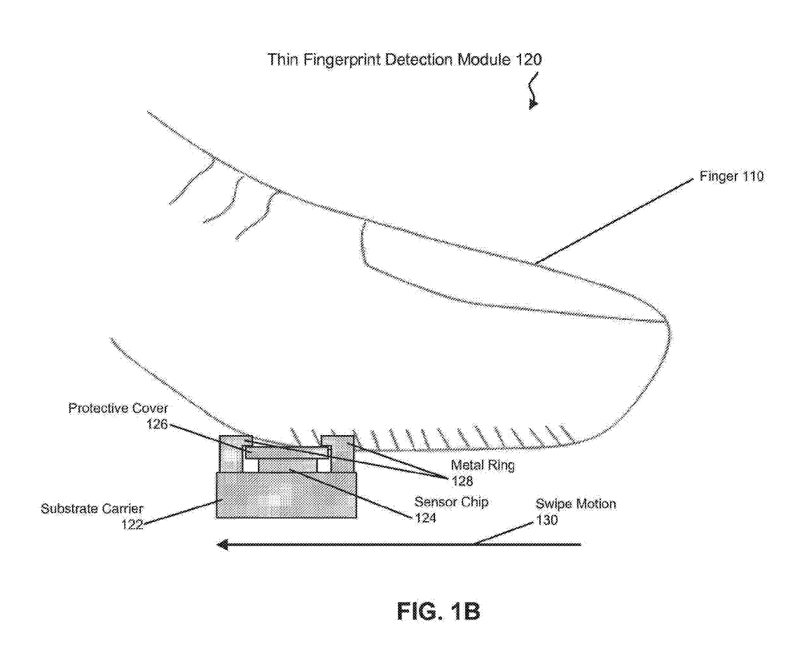

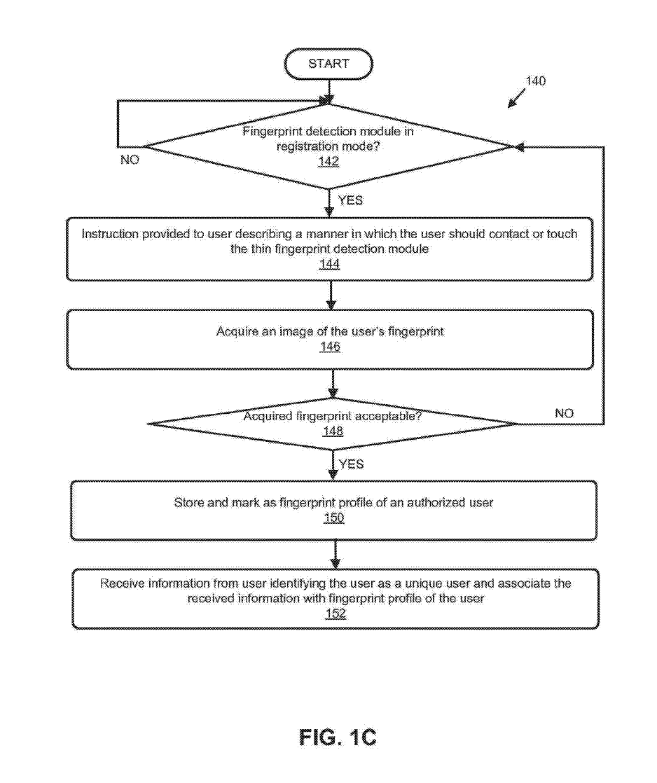

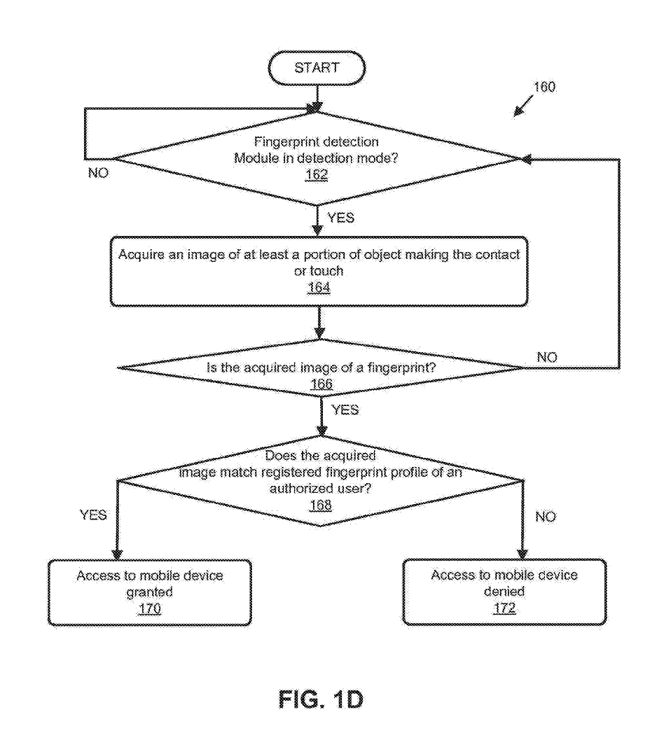

FIG. 1A shows a schematic of a cross-sectional view of a fingerprint detection module 100 (finger is not included) in accordance with some embodiments described herein. As shown in FIG. 1A, fingerprint detection module 100 includes a substrate carrier 102 and a fingerprint sensor detector chip 104 affixed on top of substrate carrier 102. Fingerprint sensor detector chip 104 can use capacitive sensing to collect fingerprint data and detect fingerprints. However, fingerprint sensor detector chip 104 can also be configured to collect fingerprint data and detect fingerprints by non-capacitive means. Fingerprint detection module 100 also includes a protective cover 106 which is placed over fingerprint sensor detector chip 104 to protect fingerprint sensor detector chip 104 and can also serve as a dielectric spacer. Protective cover 106 may be made out of high dielectric-constant material, such as ceramic, sapphire, zirconia, among others. Protective cover 106 may also have a hard coating, such as diamond like carbon. Note that in the embodiment of FIG. 1A, the edges of protective cover 106 extends beyond the edges of fingerprint sensor detector chip 104 in all directions.

Fingerprint detection module 100 additional includes a sensing or signal electrode such as a metal ring to detect a contact from a human finger or an object. The metal ring 108 is placed on substrate carrier 102 and around protective cover 106, which protects the edge of protective cover 106 in addition to serving as sensing or signal electrode. Note also that a finger 110 (not part of fingerprint detection module 100) can make contact with metal ring 108 when finger 110 is pressed on fingerprint detection module 100 for fingerprint detection.

FIG. 1B is a schematic showing a cross-sectional view of an exemplary reduced size fingerprint detection module 120 shaped in a strip. The reduced size fingerprint detection module 120 shaped in a strip is substantially similar to the fingerprint detection module 100 except the overall size or form factor of the reduced size fingerprint detection module 120 is smaller. The shape of the reduced size fingerprint detection module 120 is smaller, shorter or narrower in one (e.g., vertical) dimension to minimize or reduce real estate taken up by the reduced size fingerprint detection module 120 shaped in a strip on a mobile device, such as a smartphone. The reduced size fingerprint detection module 120 shaped in a strip includes a substrate carrier 122; a fingerprint sensor detector chip 124 affixed on top of substrate carrier 122; a protective cover 126 placed over fingerprint sensor detector chip 124; and a sensing or signal electrode such as a metal ring 128 to detect a contact from a human finger or an object.

In one example, a width of the reduced size fingerprint detection module 120 shaped in a strip is larger than a height of the reduced size fingerprint detection module 120 shaped in a strip. In another example, the height can be larger than the width of the reduced size fingerprint detection module 120 shaped in a strip. The proportion of the width verses the height can depend at least on the orientation of the reduced size fingerprint detection module 120 on a mobile device. Consistent with the reduced size of the reduced size fingerprint detection module 120 shaped in a strip, the associated substrate carrier 122, fingerprint sensor detector chip, protective cover 106 and the metal ring 108 are also reduced in size. In addition to the reduced size, the form factor and/or shape of each components in the reduced size fingerprint detection module 120 is modified to match the overall form factor and size of the reduced size fingerprint detection module having a non-uniform shape, e.g., a rectangular shape where he width is larger than the height. In order words, the number of sensor pixels in a first dimension of the fingerprint detection module is larger than a second dimension that is substantially perpendicular to the first dimension.

To accommodate the reduced form factor of the reduced size fingerprint detection module 120, a hybrid mode of operation can be implemented to cover fingerprint registration and fingerprint recognition. The hybrid mode of operation includes a swipe motion of the finger 110 as shown by arrow 130 to register an authorized user's fingerprint image and store the registered fingerprint image as a fingerprint profile of the authorized user and associate the registered fingerprint profile to the authorized user. The swipe motion to register the fingerprint image of the authorized user allows a substantially complete image of the authorized user's fingerprint to be acquired. The authorized user can be instructed during the registration portion of the hybrid operation mode to swipe the user's finger at a predetermined manner such as ‘top-down’, ‘down-up’ or “side-to-side” depending on the orientation of the reduced size fingerprint detection module 120 with respect to the authorized user and/or with respect to the mobile device on which the reduced size fingerprint detection module 120 is disposed. In addition, the authorized user may be instructed during the registration portion of the hybrid operation mode to swipe the user's finger at a constant speed, at a predetermined speed, etc. The instructions given to the authorized user regarding the manner of registering the authorized user's fingerprint image can be in the form of written text on a display screen of the mobile device, a voice recording, a sound tone, or any combination of the visual and audio instructions and indicators.

Once the fingerprint of the authorized user is registered, the same authorized user can be given access to the mobile device during the fingerprint recognition portion of the hybrid mode of operation. To access the mobile device during the fingerprint recognition portion of the hybrid mode of operation, the authorized user touches any portion of the authorized user's finger (or thumb) print on the reduced size fingerprint detection module 120. A swipe motion used during the registration portion is not needed during the recognition phase of the hybrid mode of operation. Although only a small portion of the authorized user's fingerprint is captured by the reduced size fingerprint detection module 120 due to the reduced, the captured small portion of the authorized user's fingerprint is enough to perform a matching operation against the previously registered and stored fingerprint profile associated with the authorized user. The matching process includes matching the captured fingerprint image of the portion of the authorized user fingerprint with the registered substantially full image of the authorized user's fingerprint. The image matching process can include pixel-by-pixel matching operation and can include manipulating the two images including rotating, filtering, image enhancement(s), interpolation, compression, etc. to compare the two images. The captured fingerprint image can be determined to match the registered fingerprint profile of the authorized user based on a result of the matching process satisfying a predetermined threshold. For example, the predetermined threshold can be associated with statistically significant correlation between the two images.

FIG. 1C is a process flow diagram showing an exemplary process 140 for performing a fingerprint registration mode of a hybrid mode of operation. The hybrid mode of operation 140 includes receiving a signal indicating activation or initiation of the registration mode of operation (142). For example, the received signal indicating activation of initiation of the registration mode can include a user selection (from a list of user selectable functions on a menu, for example) to initiate or activate fingerprint registration. The fingerprint registration usually occurs soon after the user purchases the mobile device to register the user as an authorized user or anytime when desiring to add or remove an authorized user to the mobile device. Until the fingerprint registration is completed for at least one authorized user, the fingerprint recognition security feature may not be active.

Responsive to the signal indicating initiation or activation of the fingerprint registration mode (142), an instruction is provided to the user describing a manner in which the user's finger or thumb should contact or touch the reduced size fingerprint detection module (144). The instruction provided can include text displayed on a display module of the mobile device, audio instructions, illustrative instructions displayed on the display module (including one or sequence of images and/or video clips), or any other visual and/or audio instructions. To accommodate the reduced size form factor and/or size of the reduced fingerprint detection module (144), a swipe motion can be suggested in the instruction. The swipe motion can include “up-down”, “down-up”, “side-to-side”, “diagonal-up”, “diagonal-down”, etc. that correspond to the orientation and/or position of the reduced size fingerprint detection module 120 with respect to the rest of the mobile device on which the reduced size fingerprint detection module 120 is located. For example, when a width of the reduced size fingerprint detection module 120 is larger than a height of the reduced size fingerprint detection module, an “up-down” or a “down-up” swipe motion can be used.

Responsive to the user making a swipe motion on the reduced size fingerprint detection module, an image of the user's fingerprint is acquired or captured (146). The acquired or captured image of the user's fingerprint is compared against a template or default human fingerprint to determine whether a substantially complete or full fingerprint image was captured (148). When determined that a substantially complete or full image of the user's fingerprint has been captured, the captured substantially complete or full image of the user's fingerprint is stored as a fingerprint profile of the user and marked as an authorized user's fingerprint profile (150).

Information such as name, phone number, address, age, etc. can be received from the user to identify the user as a unique authorized user and the received information can be included in the fingerprint profile or otherwise associated with the fingerprint profile (152).

FIG. 1D shows a process flow diagram of a process 160 for performing a fingerprint recognition mode of a hybrid mode of operation. The hybrid mode of operation 140 includes receiving a signal indicating activation or initiation of the fingerprint recognition mode of operation (162). For example, the received signal indicating activation of initiation of the registration mode can include a user touching or contacting the reduced size fingerprint detection module of a locked mobile device to initiate or activate fingerprint recognition. The user touching or contacting the reduced size fingerprint detection module can initiate a signal from the sensing electrode (e.g., metal ring 128) indicating the touch or contact.

Responsive to the signal indicating initiation or activation of the fingerprint recognition mode (162), an image of at least a portion of an object touching the reduced size fingerprint detection module is captured (164). The acquired or captured image of the user's fingerprint is compared against a template or default human fingerprint to determine whether the captured image is of a human fingerprint (166). When determined that the captured image of the object is of a human fingerprint (168), the captured image is compared with a registered fingerprint profile of an authorized user. When determined that the captured image matches the registered fingerprint profile of an authorized user, the user is granted access to the mobile device as an authorized user (170). When determined that the captured image does not match the registered fingerprint profile of an authorized user, the user is denied access to the mobile device as an authorized user (172).

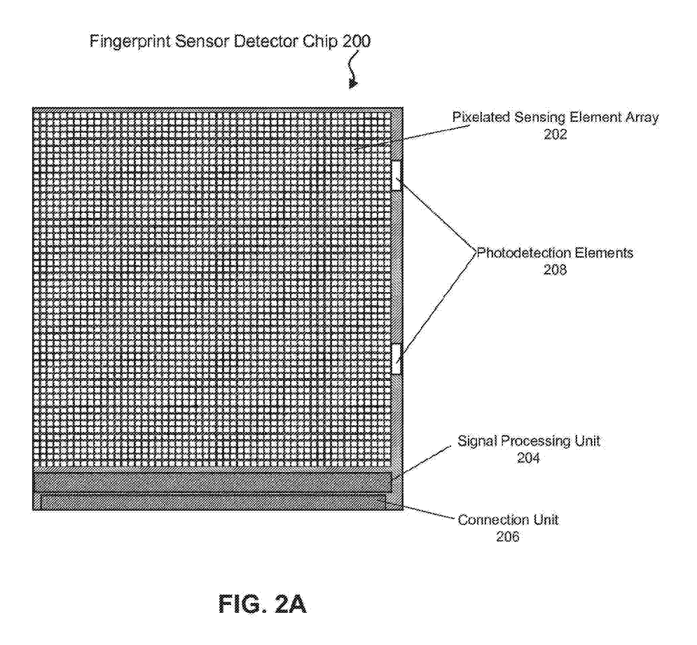

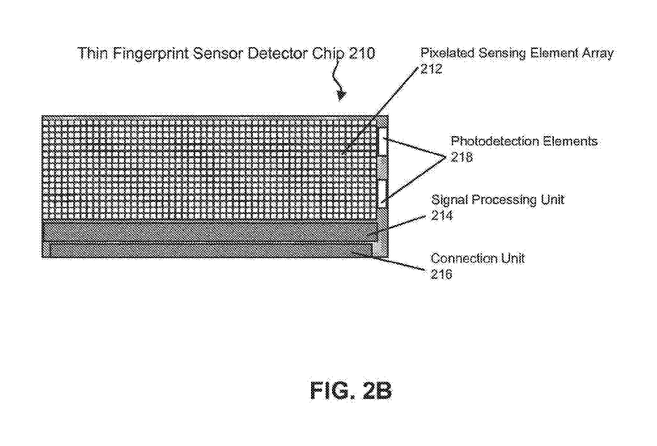

FIG. 2A shows a schematic of an exemplary fingerprint sensor detector chip 200 in accordance with some embodiments described herein. Note that fingerprint sensor detector chip 200 (or “sensor chip 200”) may be used as sensor chip 104 in fingerprint detection module 100 or in combination with other types of fingerprint detection modules described below.

As shown in FIG. 2A, fingerprint sensor detector chip 200 comprises a pixelated sensing element array 202 which occupies a significant portion of the sensor chip. Each sensing element in pixelated sensing element array 202 may be a CMOS capacitive sensor or other types of sensors capable of sensing fingerprint features. Fingerprint sensor detector can also include a signal processing unit 204 for processing signals received from pixelated sensing element array 202, and a connection unit 206 coupled to signal processing unit 204. Connection unit 206 may include multiple electrodes which can be connected to external circuitry through wire-bonding, bump bonding or other connection means. Connection unit 206 may be situated along an edge of sensor chip 200 for the convenience of interfacing with other components of a fingerprint detection module.

Note that sensor chip 200 also includes one or more photodetection elements 208, which may be located at one or more sections of sensor chip 200. Photodetection elements 208 can include, but are not limited to CMOS photodetectors, charge-coupled devices (CCD) photodetectors, light-emitting diode (LED) photodetectors, photoresistors, photovoltaic photodetectors, and photodiodes. In the embodiment shown, there are two photodetection elements located along one edge section of the sensor chip. In one embodiment, there can be just a single photodetection element or more than two photodetection elements. The multiple photodetection elements may be located at different edge sections of the silicon chip instead of all on the same side of the chip. Note that while FIG. 2A shows that photodetection elements 208 are integrated with pixelated sensing element array 202 on the same chip, other embodiments can have the photodetection elements off the sensor chip on a different area of the fingerprint sensor module.

FIG. 2B shows a schematic of an exemplary reduced size fingerprint sensor detector chip 210. The exemplary reduced size fingerprint sensor detector chip 210 (or “reduced size sensor chip 210”) can be used as sensor chip 124 in the fingerprint detection module 120 or in combination with other types of fingerprint detection modules described below. The reduced size sensor chip 210 is substantially similar to the sensor chip 200 except for a reduced size and different shape of the reduced size sensor chip 210. As shown in FIG. 2B, fingerprint sensor detector chip 200 includes a pixelated sensing element array 212 which occupies a significant portion of the sensor chip. Each sensing element in pixelated sensing element array 212 can be a CMOS capacitive sensor or other types of sensors capable of sensing fingerprint features. Fingerprint sensor detector can also include a signal processing unit 214 for processing signals received from pixelated sensing element array 212, and a connection unit 216 coupled to signal processing unit 214. Connection unit 216 may include multiple electrodes which can be connected to external circuitry through wire-bonding, bump bonding or other connection means. Connection unit 216 may be situated along an edge of sensor chip 210 for the convenience of interfacing with other components of a fingerprint detection module.

The sensor chip 210 also includes one or more photodetection elements 218, which may be located at one or more sections of sensor chip 210. Photodetection elements 218 can include, but are not limited to CMOS photodetectors, charge-coupled devices (CCD) photodetectors, light-emitting diode (LED) photodetectors, photoresistors, photovoltaic photodetectors, and photodiodes. in the embodiment shown, there are two photodetection elements located along one edge section of the sensor chip. In one embodiment, there can be just a single photodetection element or more than two photodetection elements. The multiple photodetection elements may be located at different edge sections of the silicon chip instead of all on the same side of the chip. While FIG. 2B shows that photodetection elements 218 are integrated with pixelated sensing element array 212 on the same chip, other embodiments can have the photodetection elements off the sensor chip on a different area of the fingerprint sensor module.

The reduced size sensor chip 210 can be shaped as a reduced size rectangle with a width larger than a height of the sensor chip 210. Exemplary sizes for the reduced size sensor chip 210 can include 24×88, 32×88, 56×88 pixelated sensing elements compared to the more square shaped (e.g., 64×64 pixelated sensing elements) of the sensor ship 200. The size or number of pixelated sensing elements can be reduced to obtain substantially a complete of full fingerprint image sufficient to register a user as an authorized user using a swipe motion, and to obtain sufficient portion of the user's fingerprint image from a touch or tap contact during the fingerprint recognition mode to perform a comparison against the registered fingerprint profile image. The swipe motion of the user's finger can be used to obtain an image of the user's fingerprint by using a minimum of three lines from the images captured from the pixelated sensing element array 212 to identify the different of delta between the three lines. In addition, the speed of the swipe motion can be detected from the difference between the three lines.

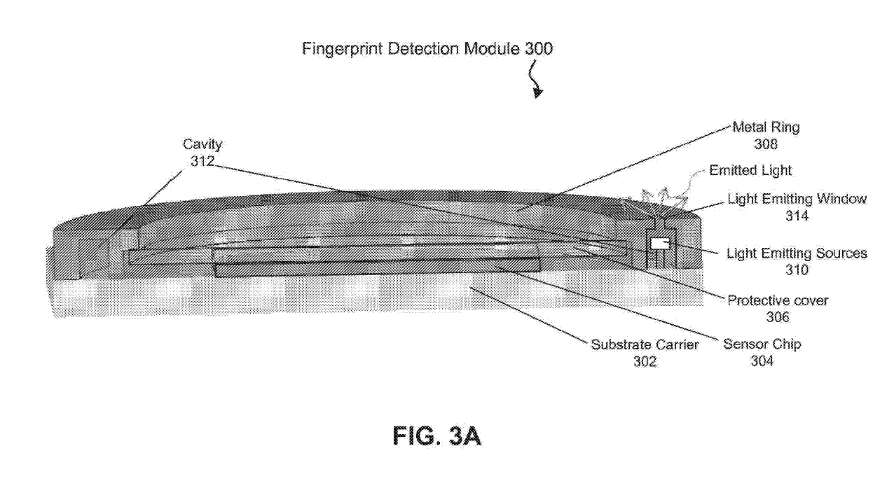

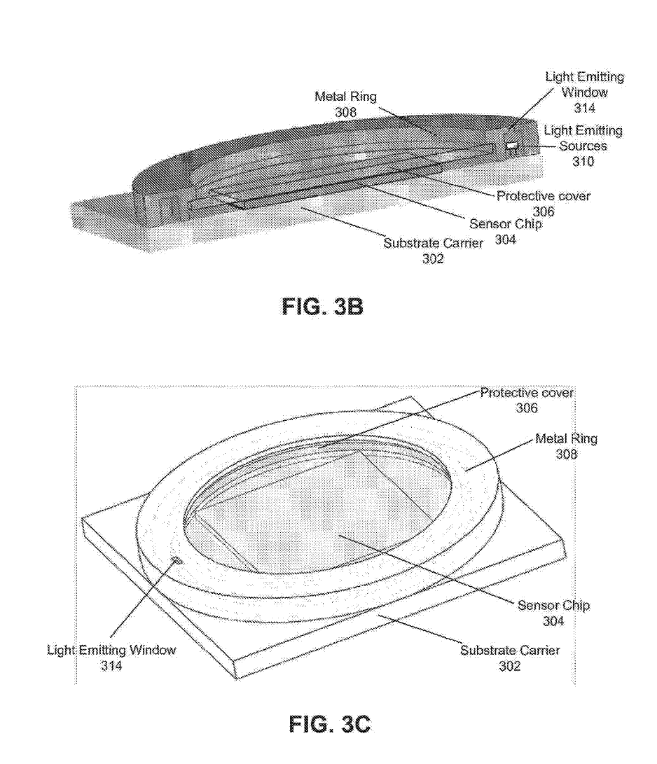

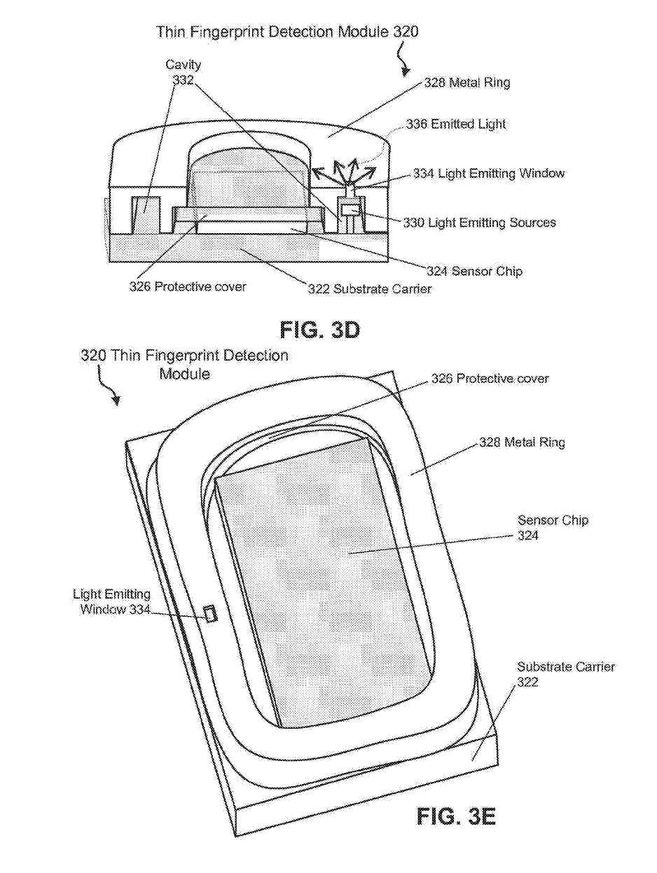

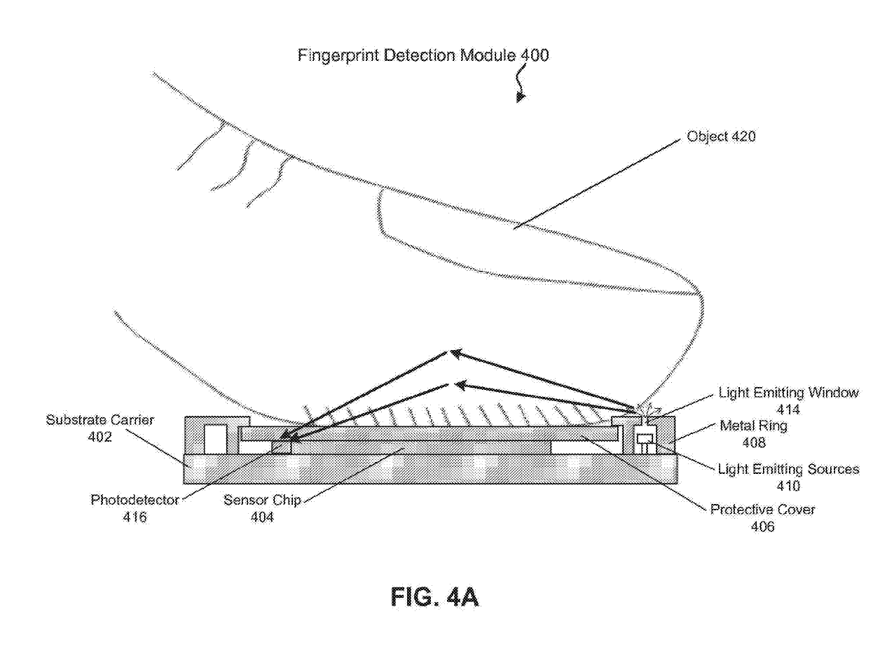

FIG. 3A shows a perspective and cross-sectional view of a fingerprint detection module 300 which includes an optical sensing mechanism for determining if a detected object is human in accordance with some embodiments described herein. Similarly to fingerprint detection module 100, fingerprint detection module 300 includes a substrate carrier 302, a fingerprint sensor detector chip 304, a protective cover 306, and a metal ring 308. Fingerprint sensor detector chip 304 can be fingerprint sensor detector chip 200 to include one or more photodetection elements. In some embodiments however, the one or more photodetection elements are located off of sensor chip 200 and on another area of substrate carrier 302 cavity protective cover 306. The protective cover can be made of transparent materials, such as sapphire or zirconia. If there are cosmetic coloring applied to protective cover 306, a transparent window may be used on protective cover 306 to allow light to go through. Note that in this embodiment, protective cover 306 covers the entire surfaces of sensor chip 304.

Fingerprint detection module 300 also includes one or more light emitting sources 310 which can be placed within a cavity 312 of metal ring 308. Light emitting sources 310 can include one or more light emitting diode (LED) chips, one or more diode lasers, or one or more other miniature light emitting devices. An exemplary LED chip in such applications can have an area of ˜200 μm×200 μm and a thickness of ˜200 μm. In the embodiment shown, cavity 312 has a ring structure which is formed around the underside of metal ring 308. However, cavity 312 in metal ring 308 can have many other configurations, for example, to only present around the locations of light emitting sources 310.

Light emitting sources 310 can be configured to emit detection light of desirable wavelengths in response to a human finger or an object making contact with fingerprint detection module 300. For example, metal ring 308 can serve as a sensing electrode to detect the contact from a human finger or an object. Light emitting sources 310 can emit light through one or more light emitting windows which cut through metal ring 308 to connect to cavity 312. In FIG. 3A, a light emitting window 314 is located directly above one of the light emitting sources 310 inside cavity 312. In some embodiments, light emitting sources 310 include a modulated light source.

FIG. 3B provides another perspective and cross-sectional view of fingerprint detection module 300 in accordance with some embodiments described herein. FIG. 3C provides a perspective view of entire fingerprint detection module 300 in accordance with some embodiments described herein.

FIG. 3D shows a cross-sectional view of an exemplary reduced size fingerprint detection module 320 which includes an optical sensing mechanism for determining whether a captured image of an object making contact matches a registered fingerprint profile of an authorized user. The reduced size fingerprint detection module 320 is substantially similar to the fingerprint detection module 300 except for a reduced size and a different shape of the reduced size fingerprint detection module 320. As described above with respect to the reduced size fingerprint detection module 120, the size and shape of the reduced size fingerprint detection module 320 is smaller, shorter or narrower in one (e.g., vertical) dimension to minimize or reduce real estate taken up by the reduced size fingerprint detection module 320 shaped in a strip on a mobile device, such as a smartphone. In one example, a width of the reduced size fingerprint detection module 320 is larger than a height of the reduced size fingerprint detection module 320.

To accommodate the smaller, shorter or narrower form factor and/or size of the reduced fingerprint detection module 320, a swipe motion can be suggested in the instruction. The swipe motion can include “up-down”, “down-up”, “side-to-side”, “diagonal-up”, “diagonal-down”, etc. that correspond to the orientation and/or position of the reduced size fingerprint detection module 320 with respect to the rest of the mobile device on which the reduced size fingerprint detection module 320 is located. For example, when a width of the reduced size fingerprint detection module 320 is larger than a height of the reduced size fingerprint detection module, an “up-down” or a “down-up” swipe motion can be used.

Similarly to the reduced size fingerprint detection module 120, the reduced size fingerprint detection module 320 includes a substrate carrier 322, a fingerprint sensor detector chip 324, a protective cover 326, and a sensing electrode such as a metal ring 328. Reduced size fingerprint sensor detector chip 324 can be substantially similar to reduced size fingerprint sensor detector chip 210 to include one or more photodetection elements. In some embodiments however, the one or more photodetection elements are located off of sensor chip 324 and on another area of substrate carrier cavity protective cover 326. The protective cover 326 can be made of transparent materials, such as sapphire or zirconia. When a cosmetic coloring is applied to protective cover 326, a transparent window may be used on protective cover 326 to allow light to go through. The protective cover 326 can cover the entire surface of the reduced size sensor chip 324.

Reduced size fingerprint detection module 320 also includes one or more light emitting sources 330 which can be placed within a cavity 332 of a sensing electrode such as a metal ring 328. Light emitting sources 330 can include one or more light emitting diode (LED) chips, one or more diode lasers, or one or more other miniature light emitting devices. An exemplary LED chip in such applications can have an area of ˜200 μm×200 μm and a thickness of ˜200 μm. In the embodiment shown, cavity 332 has a ring structure which is formed around the underside of metal ring 308. However, cavity 332 in metal ring 328 can have many other configurations, for example, to only present around the locations of light emitting sources 330.

Light emitting sources 310 can be configured to emit detection light of desirable wavelengths in response to a human finger or an object making contact with the reduced size fingerprint detection module 320. For example, metal ring 328 can serve as a sensing electrode to detect the contact from a human finger or an object. Light emitting sources 330 can emit light through one or more light emitting windows which cut through metal ring 328 to connect to cavity 332. In FIG. 3D, a light emitting window 334 is located directly above one of the light emitting sources 330 inside cavity 332. In some embodiments, light emitting sources 330 include a modulated light source.

FIG. 3D shows a top-down perspective view of the reduced size fingerprint detection module 320.

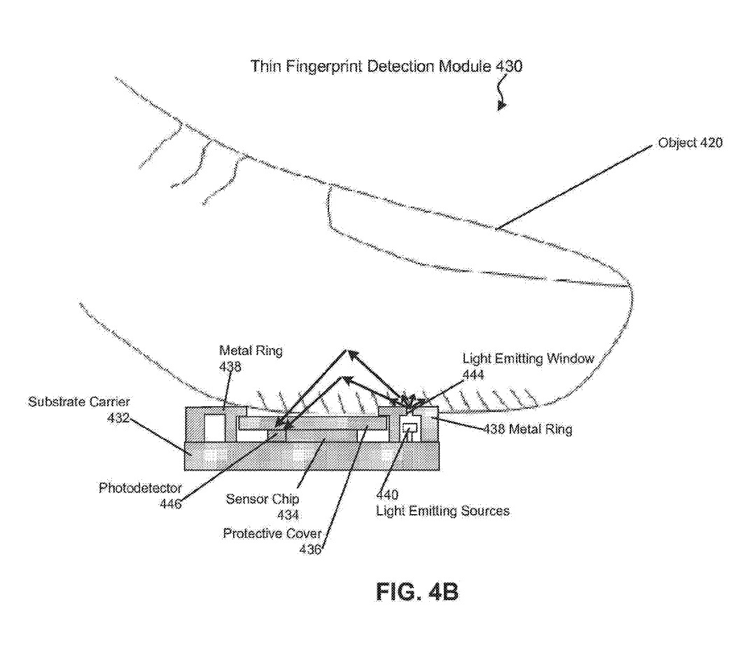

FIG. 4A illustrates the concept of using a fingerprint detection module 400 (which is substantially similar to fingerprint detection module 300) to detect and determine if a detected object is human in accordance with some embodiments described herein. While FIG. 4A is described in the context of fingerprint detection module 400, the techniques described herein are general applicable to many variations of fingerprint detection module 400, some of which will be described later in the disclosure.

As mentioned above, fingerprint detection module 400 includes substrate carrier 402, protective layer 406, metal ring 408 and sensor chip 404, which may include a capacitive sense array for sensing a fingerprint's ridge and valley patterns. Fingerprint detection module 400 includes light emitting sources 410 which reside within a cavity under metal ring 408. In some implementations, light emitting sources 410 can emit at least two different wavelengths through light emitting window 414 of metal ring 408. Fingerprint detection module 400 also includes one or more photodetectors 416 which can either be integrated on sensor chip 404 or separately placed on substrate carrier 402. In the embodiment shown, photodetectors 416 are located on an edge of sensor chip 404.

In some implementations, when an object 420 (not part of fingerprint detection module 400) makes contact of fingerprint detection module 400, light emitting sources 410 emits detection light through light emitting window 414. The detection light is reflected off object 420 and the reflected light can be received and measured by photodetectors 416. In particular implementations, two wavelengths of detection light are emitted by light emitting sources 410. For example, one wavelength can be 660 nm and the other wavelength is one of 905 nm, 910 nm or 940 nm. In another embodiment, the two wavelengths are 590 nm and 805 nm. In yet another embodiments, the two wavelengths are 520 nm and 575 nm.

FIG. 4B shows a concept of using a reduced size fingerprint detection module 430 (which is substantially similar to fingerprint detection module 320) to determine whether an image captured from an object making contact with the reduced size fingerprint detection module 430 matches a registered fingerprint profile of an authorized user. For example, FIG. 4B shows a user operating in the fingerprint recognition mode to capture an image of at least a portion of the user's fingerprint and comparing the captured image against the registered fingerprint profile of an authorized user to determine whether the user is an authorized user.

The reduced size fingerprint detection module 430 is substantially similar to the fingerprint detection module 400 except for a reduced size and a differing shape of the reduced size fingerprint detection module 430. As described above with respect to the reduced size fingerprint detection modules 120 and 320, the size and shape of the reduced size fingerprint detection module 430 is smaller, shorter, narrower in one (e.g., vertical) dimension to minimize or reduce real estate taken up by the reduced size fingerprint detection module 430 on a mobile device, such as a smartphone. In one example, a width of the reduced size fingerprint detection module 430 is larger than a height of the reduced size fingerprint detection module 430 shaped in a strip.

To accommodate the smaller, shorter, narrower form factor and/or size of the reduced fingerprint detection module 430, a swipe motion can be suggested in the instruction. The swipe motion can include “up-down”, “down-up”, “side-to-side”, “diagonal-up”, “diagonal-down”, etc. that correspond to the orientation and/or position of the reduced size fingerprint detection module 430 with respect to the rest of the mobile device on which the reduced size fingerprint detection module 430 is located. For example, when a width of the reduced size fingerprint detection module 430 is larger than a height of the reduced size fingerprint detection module, a “up-down” or a “down-up” swipe motion can be used.

The reduced size fingerprint detection module 430 includes a substrate carrier 432, a protective layer 436, a sensing electrode such as a metal ring 438, and a sensor chip 434, which may include a capacitive sense array for sensing a fingerprint's ridge and valley patterns. Fingerprint detection module 430 includes light emitting sources 440 which reside within a cavity under metal ring 438. In some implementations, light emitting sources 440 can emit at least two different wavelengths through light emitting window 444 of metal ring 438. The reduced size fingerprint detection module 430 also includes one or more photodetectors 446 which can either be integrated on sensor chip 434 or separately placed on substrate carrier 432. In the embodiment shown, photodetectors 446 are located on an edge of sensor chip 434.

In some implementations, when an object 420 (not part of fingerprint detection module 400) makes contact with the reduced size fingerprint detection module 430, light emitting sources 440 emits detection light through light emitting window 444. The detection light is reflected off object 420 and the reflected light can be received and measured by photodetectors 446. Two wavelengths of detection light can be emitted by light emitting sources 440. For example, one wavelength can be 660 nm and the other wavelength is one of 905 nm, 910 nm or 940 nm. In another embodiments, the two wavelengths are 590 nm and 805 nm. In yet another embodiments, the two wavelengths are 520 nm and 575 nm.

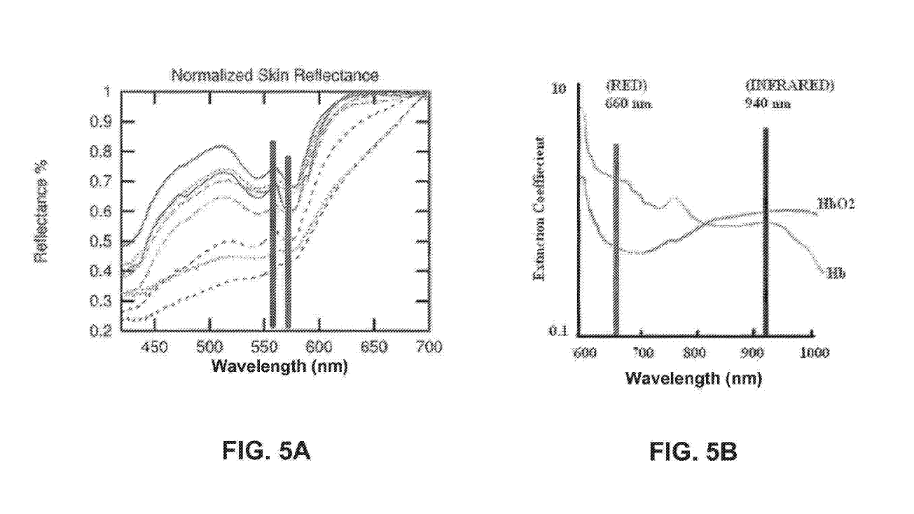

FIG. 5A shows a data plot of normalized human skin reflectance (in %) as a function of the wavelength of the light source in accordance with some embodiments described herein. Note that human skin has different reflectance in response to different wavelengths and this relationship can be measured. As a result, the photodetector signals corresponding to the reflected light from the two selected wavelengths can be significantly different. In some implementations, photodetectors 416 can be configured to measure the reflected light from both wavelengths. The ratio of the two measurements can then be computed and compared to a standard or calibrated value for human finger/skin to determine if object 420 is human finger or not. The computation, comparison, and determination operations can be performed by an on chip signal processing unit such as signal processing unit 204 shown in FIG. 2.

FIG. 5B shows a data plot of human blood light absorption property (in extinction coefficient) as a function of the wavelength of the light source in accordance with some embodiments described herein. Note that human blood has different absorptions in response to different wavelengths. Moreover, for blood Hemoglobin lack of Oxygen (referred to as “Hb state”) and bound with Oxygen (referred to as “HbO2 state”), the absorption behaviors are also significantly different. As a result, the photodetector signals corresponding to the reflected light from the two selected wavelengths can be significantly different, and the photodetector signals corresponding to the reflected light from the same wavelength under Hb or HbO2 state can also be significantly different. In some implementations, photodetectors 416 can be configured to measure the transmitted light through object 420 for both wavelengths. The ratio of the two measurements can then be computed and compared to a standard or calibrated value for human blood absorption to determine if object 420 is human finger or not. The computation, comparison, and determination operations can be performed by an on-chip signal processing unit such as signal processing unit 204 shown in FIG. 2.

Photodetectors 416 can also be configured to measure the transmitted light through object 420 for one or both wavelengths under both Hb state and HbO2 state. The ratio of the two measurements at two different wavelengths in each of the two states can then be computed and compared to standard or calibrated values for human blood absorption to determine if object 420 is human finger or not. The computation, comparison, and determination operations can be performed by an on-chip signal processing unit such as signal processing unit 204 shown in FIG. 2.

The above measurements in FIG. 5A or 5B or both at the two different optical wavelengths can also be used to measure the person's heartbeat based on the oxygen level in the blood due to pumping by the heart. The two different wavelengths can be at the red spectral range and the infrared spectral range, respectively. The heartbeat measurement is used in some pulse oximeter devices or heart rate monitors based on measurements of the saturated level of oxygen in the blood. The relative absorption of red (absorbed by oxygenated blood) and infrared (absorbed by deoxygenated blood) light correlates to arterial blood oxygen saturations. Measurements of relative light absorption are made and are processed to generate the heart beat rate. This heart beat measurement provides another check on whether the person is present when the fingerprint pattern is presented to the target device that is to be accessed.

As mentioned above, a touch sensor within the fingerprint detection module, such as metal ring 408 in fingerprint detection module 400 can be used to detect the initial contact of an object, such as a user's finger. In one embodiment, the metal ring may be part of circuitry for initial contact detection and module activation. In some embodiments, the fingerprint detection module can be in a standby mode (i.e., power saving mode) before the detection of a new contact. Upon detecting a new contact, the metal ring circuitry then activates the main circuit of the fingerprint detection module. When a current fingerprint detection and authentication process is complete, the main circuitry of the fingerprint detection module can be turned off or deactivated and the fingerprint detection module returns to the standby mode while the metal ring circuitry remains active and ready for next contact.

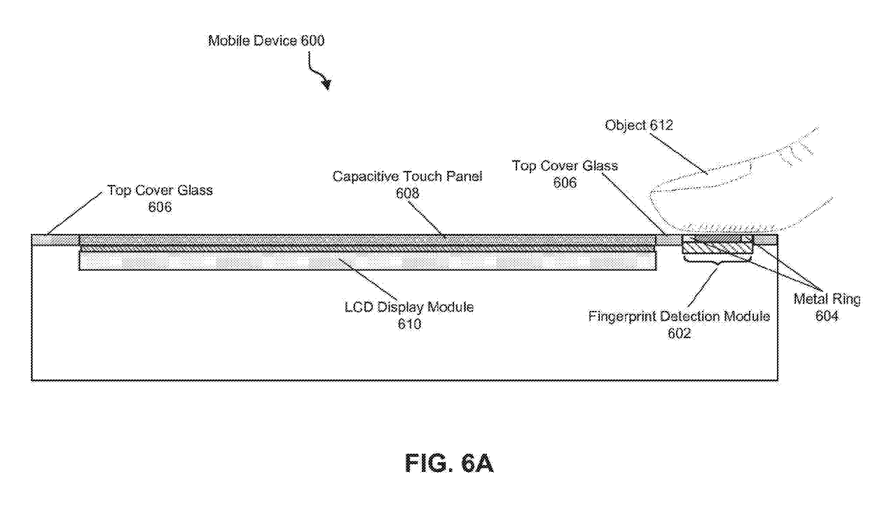

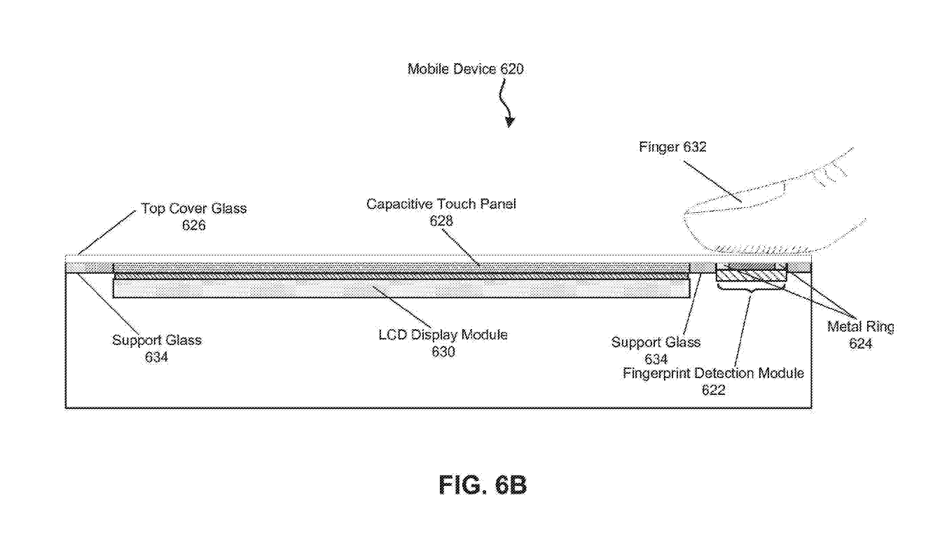

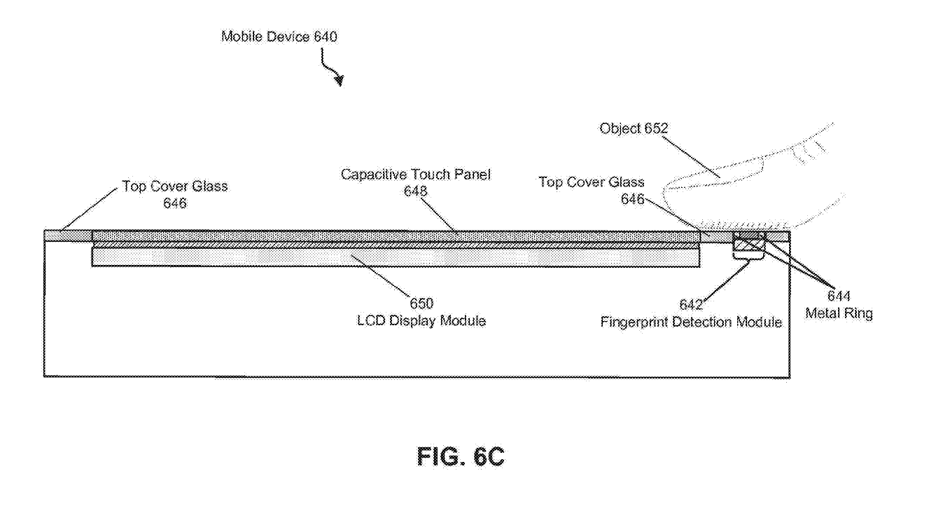

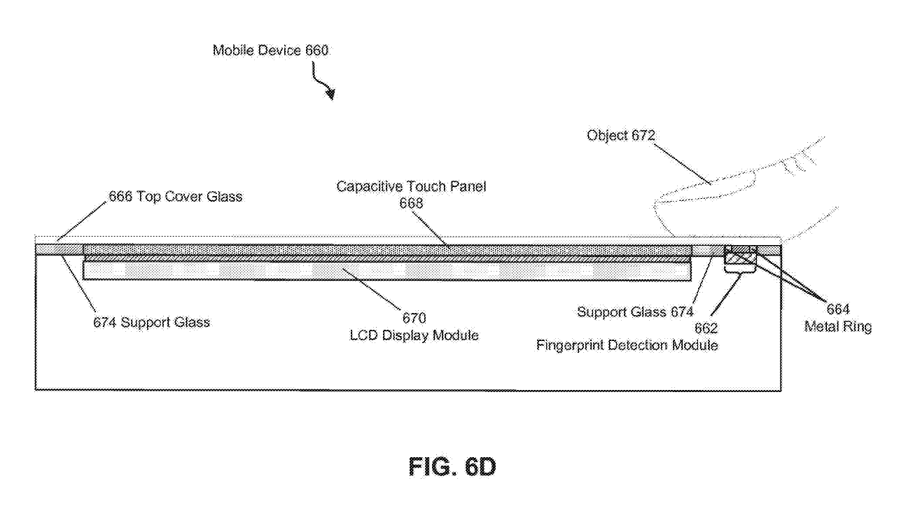

FIG. 6A is a schematic showing a cross sectional view of an exemplary mobile device 600 integrated with a touch screen assembly and a fingerprint detection module in accordance with some embodiments described herein, As shown in FIG. 6A, mobile device 600 (e.g., a smartphone) includes a fingerprint detection module 602 having a touch sensor such as a metal ring 604 positioned to be substantially level with a surface of mobile device 600 parallel with a surface of top cover glass 606 exposed to the user. The touch sensor can be implemented using any conductive material, such as any number of known metals. In addition, the shape of the touch sensor can vary based on the shape and design of the fingerprint detection module. The touch sensor can be designed to border at or near the outline of the fingerprint detection module so as to substantially surround the portion of the fingerprint detection module exposed to a user. For example, for a fingerprint detection module in a round shape, a metal ring can be used as the touch sensor. For a fingerprint detection module shaped as a rectangle, the touch sensor can be formed in the shape of a rectangular frame. The top cover glass 606 of mobile device 600 includes an opening to allow fingerprint detection module 602 to fit through and be exposed on the surface. In addition, top glass 606 can be implemented using transparent materials other than glass including various crystalline structures, such as sapphire that provides the mobile device 600 with protection while allowing at least visible light to pass through. Mobile device 600 also includes a touch panel 608 and an LCD display module 610 positioned underneath capacitive touch panel 608. Touch panel 608 can be implemented using various touch technologies including a capacitive touch sensor, an inductive touch sensor, and other touch sensors. The touch panel and the LCD display module 610 together form the touch screen assembly. When mobile device 600 is locked, LCD display module 610 is turned off and a main processor of mobile device 600 and fingerprint detection module 602 are in standby mode. To unlock mobile device 600, a user can make contact with the fingerprint detection module 602 with the user's finger, for example. A touch sensor such as metal ring 604 and associated circuitry communicatively coupled to the metal ring 604 can be used to detect a contact from an object 612 with the fingerprint detection module 602. The touch sensor and associated circuitry can be used to activate fingerprint detection module 602 responsive to a light contact, without additional user input through a mechanical switch, such as actuating a physical button.

FIG. 6B is a schematic showing a cross sectional view of another exemplary mobile device 620 integrated with a touch screen assembly and a fingerprint detection module in accordance with some embodiments described herein. Similar to mobile device 600 in FIG. 6A, mobile device 620 includes a fingerprint detection module 622 having a touch sensor, such as a metal ring 624. However, different from mobile device 600, the top cover glass 626 of mobile device 620 does not have an opening to expose the top surface (e.g., the surface exposed to the user) of fingerprint detection module 622. Instead, fingerprint detection module 622 is positioned underneath top cover glass 626 and is designed to sense a fingerprint of a finger without being directly in contact with the finger 632.

In the embodiment of FIG. 6B, top cover glass 626 protects touch panel 628 and LCD display module 630 of the touch screen assembly and other areas of a top surface of mobile device 620 substantially parallel with the top cover glass 626 beyond the touch sensitive area associated with the touch panel, including a location above fingerprint detection module 622. Touch panel 628 is embedded within a support glass 634 underneath top cover glass 626. Top cover glass 626 and support glass 634 can be implemented using materials similar to top cover glass 606. Support glass 634 includes an opening to allow fingerprint detection module 622 to pass through and be placed under the top cover glass 626. The location of the opening in support glass 634 may be closer to one end of support glass 634, similar to the relative location of the opening in top cover glass 606 in FIG. 6A. The fingerprint detection module 622 in this design can sense a contact from a fingerprint of a finger 632 with a top surface (e.g., the surface exposed to the user) of the hardened top cover glass 626 without having an object such as the finger 632 being in direct contact with a surface on the fingerprint detection module 622. This allows top cover glass 626 to fully cover both the touch screen assembly and the fingerprint sensor under a spatially contiguous protective surface without an opening.

In one embodiment, top cover glass 626 and support glass 634 are bonded together to form an overall cover glass structure that is significantly thicker and mechanically stronger than each of top cover glass 626 and support glass 634 individually. The two glass layers may be bonded with a thin adhesive layer, such as an epoxy adhesive layer. The overall thickness of the combined structure may be comparable to top cover glass 606 in FIG. 6A. Fingerprint detection module 622 which is positioned within the opening of support glass 634 may be directly attached underneath top cover glass 626.

In everyday uses when a user is holding or carrying mobile device 600 or mobile device 620 (e.g., in a pocket close to the body), unintended and incidental contacts on metal ring 604 or an surface area directly above metal ring 624 are common and can be difficult to avoid. Activation of fingerprint detection module 602 or 622 and/or the main processor of mobile device 600 or 620 from a standby mode due to unintended contacts with the touch sensor can negatively impact power consumption of a mobile device. Devices, systems, and techniques described in various embodiments of this document can potentially enable light contact activation of fingerprint detection module 602 or 622 while preventing unintended contacts from activating the same fingerprint detection module 602 or 622 and/or mobile device 600 or 620 from a standby mode.

FIG. 6C is a schematic showing a cross sectional view of an exemplary mobile device 640 integrated with a touch screen assembly and a reduced size fingerprint detection module 642 shaped in a strip. The reduced size fingerprint detection module 642 is substantially similar to the fingerprint detection module 640 in FIG. 6A except for the reduced size and a differing shape of the reduced size fingerprint detection module 642.

As described above with respect to the reduced size fingerprint detection modules 120, 320 and 430, the size and shape of the reduced size fingerprint detection module 642 is smaller, shorter, narrower in one (e.g., vertical) dimension to minimize or reduce real estate taken up by the reduced size fingerprint detection module 642 on the mobile device 640, such as a smartphone. In one example, a width of the reduced size fingerprint detection module 642 is larger than a height of the reduced size fingerprint detection module 642 shaped in a strip.

To accommodate the smaller, shorter, narrower form factor and/or size of the reduced fingerprint detection module 642, a swipe motion can be suggested in the instruction. The swipe motion can include “up-down”, “down-up”, “side-to-side”, “diagonal-up”, “diagonal-down”, etc. that correspond to the orientation and/or position of the reduced size fingerprint detection module 642 with respect to the rest of the mobile device on which the reduced size fingerprint detection module 642 is located. For example, when a width of the reduced size fingerprint detection module 642 is larger than a height of the reduced size fingerprint detection module, a “up-down” or a “down-up” swipe motion can be used. When the height is larger than the width, a “side-to-side” motion can be used.

The mobile device 640 (e.g., a smartphone) includes a fingerprint detection module 642 having a touch sensor or sensor electrode such as a metal ring 644 positioned to be substantially level with a surface of mobile device 640 parallel with a surface of top cover glass 646 exposed to the user. The touch sensor or sensor electrode can be implemented using any conductive material, such as any number of known metals. In addition, the shape of the touch sensor can vary based on the shape and design of the fingerprint detection module. The touch sensor can be designed to border at or near the outline of the fingerprint detection module so as to substantially surround the portion of the fingerprint detection module exposed to a user. For example, for a fingerprint detection module in a round shape, a metal ring can be used as the touch sensor. For a fingerprint detection module shaped as a rectangle, the touch sensor can be formed in the shape of a rectangular frame. The top cover glass 646 of mobile device 640 includes an opening to allow fingerprint detection module 642 to fit through and be exposed on the surface. In addition, top glass 646 can be implemented using transparent materials other than glass including various crystalline structures, such as sapphire that provides the mobile device 640 with protection while allowing at least visible light to pass through. Mobile device 640 also includes a touch panel 648 and an LCD display module 650 positioned underneath capacitive touch panel 648. Touch panel 648 can be implemented using various touch technologies including a capacitive touch sensor, an inductive touch sensor, and other touch sensors. The touch panel and the LCD display module 650 together form the touch screen assembly. When mobile device 640 is locked, LCD display module 650 is turned off and a main processor of mobile device 640 and fingerprint detection module 642 are in standby mode. To unlock mobile device 640, a user can make contact with the fingerprint detection module 642 with the user's finger, for example. A touch sensor or sensor electrode such as metal ring 644 and associated circuitry communicatively coupled to the metal ring 644 can be used to detect a contact from an object 652 with the fingerprint detection module 642. The touch sensor and associated circuitry can be used to activate fingerprint detection module 642 responsive to a light contact, without additional user input through a mechanical switch, such as actuating a physical button.

FIG. 6D is a schematic showing a cross sectional view of another exemplary mobile device 660 integrated with a touch screen assembly and a fingerprint detection module in accordance with some embodiments described herein. Similar to mobile device 640 in FIG. 6C, mobile device 660 includes a reduced fingerprint detection module 662 substantially similar to reduced fingerprint detection module 642 having a touch sensor or a sensor electrode, such as a metal ring 664. However, different from mobile device 640, the top cover glass 666 of mobile device 660 does not have an opening to expose the top surface (e.g., the surface exposed to the user) of fingerprint detection module 662. Instead, fingerprint detection module 662 is positioned underneath top cover glass 666 and is designed to sense a fingerprint of a finger without being directly in contact with the finger 672.

In the embodiment of FIG. 6D, top cover glass 666 protects touch panel 668 and LCD display module 670 of the touch screen assembly and other areas of a top surface of mobile device 620 substantially parallel with the top cover glass 666 beyond the touch sensitive area. associated with the touch panel, including a location above fingerprint detection module 662. Touch panel 668 is embedded within a support glass 674 underneath top cover glass 666. Top cover glass 666 and support glass 674 can be implemented using materials similar to top cover glass 646. Support glass 674 includes an opening to allow fingerprint detection module 662 to pass through and be placed under the top cover glass 666. The location of the opening in support glass 674 may be closer to one end of support glass 674, similar to the relative location of the opening in top cover glass 646 in FIG. 6D. The fingerprint detection module 662 in this design can sense a contact from a fingerprint of a finger 672 with a top surface (e.g., the surface exposed to the user) of the hardened top cover glass 666 without having an object such as the finger 672 being in direct contact with a surface on the fingerprint detection module 662. This allows top cover glass 666 to fully cover both the touch screen assembly and the fingerprint sensor under a spatially contiguous protective surface without an opening.

In one embodiment, top cover glass 666 and support glass 674 are bonded together to form an overall cover glass structure that is significantly thicker and mechanically stronger than each of top cover glass 666 and support glass 674 individually. The two glass layers may be bonded with a thin adhesive layer, such as an epoxy adhesive layer. The overall thickness of the combined structure may be comparable to top cover glass 666 in FIG. 6A. Fingerprint detection module 662 which is positioned within the opening of support glass 674 may be directly attached underneath top cover glass 666.

In everyday uses when a user is holding or carrying mobile device 640 or mobile device 660 (e.g. in a pocket close to the body), unintended and incidental contacts on metal ring 644 or an surface area directly above metal ring 664 are common and can be difficult to avoid. Activation of fingerprint detection module 642 or 652 and/or the main processor of mobile device 640 or 660 from a standby mode due to unintended contacts with the touch sensor can negatively impact power consumption of a mobile device. Devices, systems, and techniques described in various embodiments of this document can potentially enable light contact activation of fingerprint detection module 642 or 662 while preventing unintended contacts from activating the same fingerprint detection module 642 or 662 and/or mobile device 640 or 660 from a standby mode.

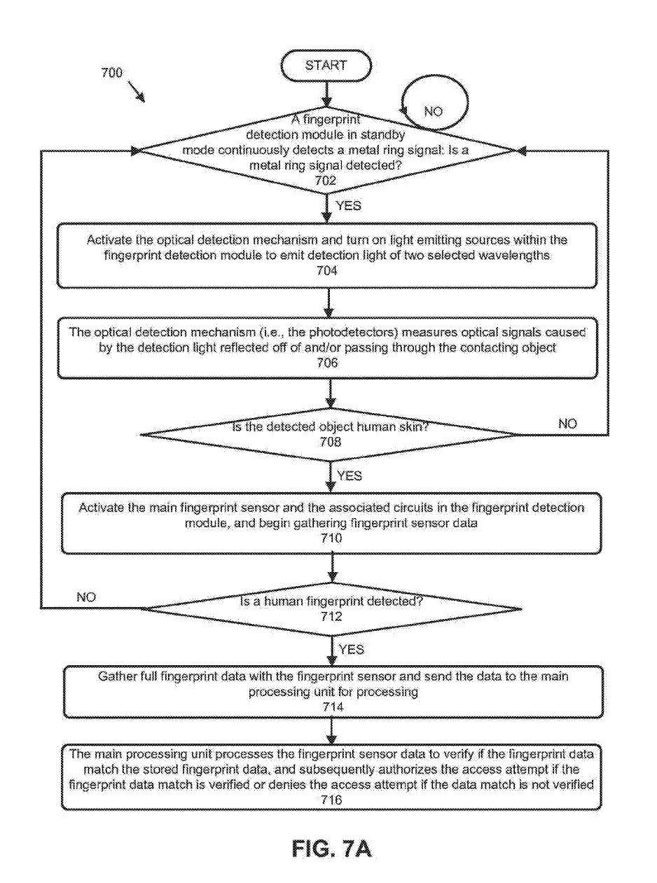

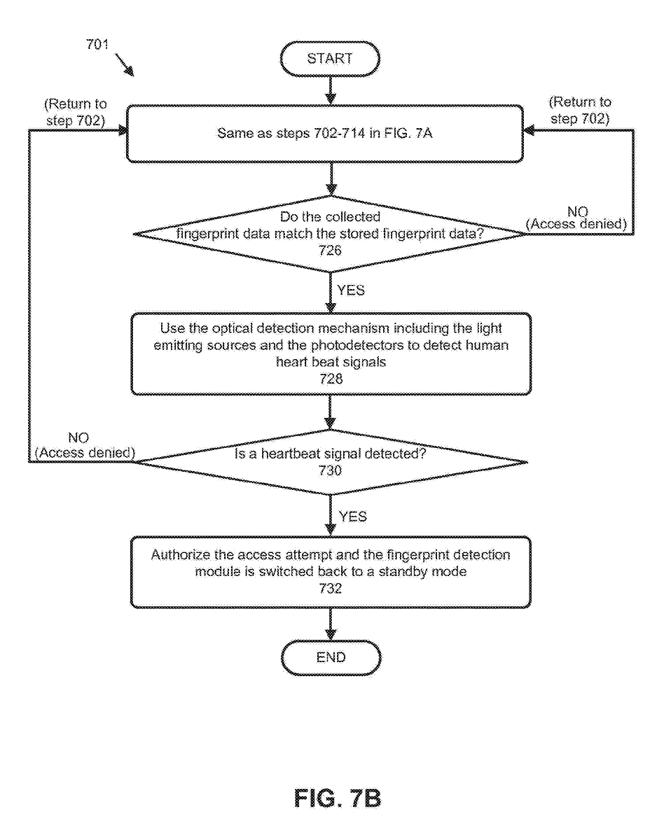

FIG. 7A presents a flowchart illustrating an exemplary process 700 of activating a fingerprint detection module from standby mode and using the fingerprint detection module to authenticate a user's request to gain access to a locked mobile device in accordance with some embodiments described herein. The exemplary process 700 of FIG. 7A is described with respect to fingerprint detection module 400 or 430 and mobile device 600 or 620. A fingerprint detection module (e.g., fingerprint detection module 400 or 430) in standby mode has a touch sensor enabled to continuously receive from the touch sensor a touch sensor signal (e.g., a metal ring signal from the metal ring touch sensor) indicating a contact from an object with the touch sensor (e.g., metal ring) and the fingerprint detection module (702). In one embodiment, the metal ring touch sensor (e.g., metal ring 408 in fingerprint detection module 400 or metal ring 438 in reduced size fingerprint detection module 430) of the fingerprint detection module and associated touch sensing circuitry (which may be integrated with sensor chip 404 or reduced size sensor chip 434) are used for the contact detection. For example, the associated touch sensing circuitry can generate a signal in response to an increase of capacitive load on the metal ring caused by an object, such as a finger, making contact with the metal ring. Note that light emitting sources within the fingerprint detection module are not enabled at this point. Until a metal ring signal is detected at 702, the fingerprint detection module stays in standby mode waiting for the metal ring signal indicating a detected contact as shown in FIG. 7A.

Responsive to the fingerprint detection module receiving a metal ring signal from the touch sensor and associated touch sensing circuitry, the fingerprint detection module activates an optical detection module and turns on light emitting sources, such as LEDs within the fingerprint detection module to emit detection light of two selected wavelengths (704). The optical detection module includes one or more photodetectors within the fingerprint detection module (e.g., photodetector 416 in module 400) to measure optical signals associated with the emitted detection light reflecting off of the contacting object and/or the emitted detection light passing through (i.e., transmitted light) the contacting object (706). The detection light passing through the contacting object can be used to determine a light absorption property of the contacting object. A signal processing module processes photodetector signals corresponding to the measured optical signals in two predetermined wavelengths. Based at least partially on the processed photodetector signals, the signal processing module determines whether the detected contact is from human skin by comparing computed signal ratios of the processed photodetector signals at two selected wavelengths with the characteristic values of the same parameters of human skin (708). In some implementations, the optical detection module is integrated with the fingerprint sensor chip.

When the determination at 708 is that the detected contact is not from human skin, the fingerprint detection module is switched back to the standby mode (702). For example, the detected contact could be based on a non-human-skin object making contact with the metal ring, such as human body touching the metal ring through clothing. In one implementation, returning to the standby mode also involves turning off the light emitting sources. However, when the determination at 708 is that the detected contact is from human skin, the fingerprint detection module activates the main fingerprint sensor and the associated circuitry in the fingerprint detection module, and begins obtaining fingerprint sensor data from the human skin (710).

The fingerprint detection module processes the obtained fingerprint sensor data to determine whether a human fingerprint is detected (712). This is performed prior to full fingerprint verification to distinguish a human fingerprint from another part of human skin, such as another part of a human hand, human arm, and human face, making contact with the fingerprint detection module. In some implementations, the initial determination of human fingerprint at 712 does not obtain and process the full fingerprint data in order to save power and processing time. For example, the fingerprint sensor measures one-directional (1D) human skin profile and associated detection circuitry determines whether the measured 1D skin profile substantially matches a human fingerprint. The detection circuitry associated with the fingerprint sensor can compare the measured 1D skin profile with a typically 1D fingerprint contour that includes a periodic ridge and valley pattern and determine whether the measured 1D skin profile resembles a human fingerprint. Moreover, the detection circuitry used to perform the initial determination of human fingerprint at 712 can be low power detection circuitry within the fingerprint detection module, for example, circuitry integrated with the sensor chip. As such, performing the initial determination of human fingerprint at 712 does not require the main processor (e.g., the application processor) of the mobile device, which can remain in standby mode until full fingerprint verification is needed. Using partial fingerprint data and low power circuitry can ensure low power consumption at 710 and 712.

When the determination at 712 is that a human fingerprint is not detected from the human skin, the fingerprint detection module again is switched back to the standby mode at 702. For example, the detected contact from human skin without a human fingerprint can be the result of a contact from a side of the user's hand, arm or face with the metal ring. In one implementation, returning to the standby mode of 702 also includes turning off the light emitting sources.

When the determination at 712 is that the detected contact is from a human fingerprint, the fingerprint detection module then obtains full fingerprint data with the fingerprint sensor and sends the obtained full fingerprint data to the main processing unit for processing (714), which may involve waking up the main processing unit from the standby mode. The full fingerprint sensor data is processed by the main processing unit to verify whether the obtained full fingerprint data match the stored fingerprint data of an authorized user of the mobile device. Based on the outcome of the verification, the main processing unit authorizes or denies user access to the locked mobile device (716). The fingerprint detection module is switched back to the standby mode at 702 if access is denied. Otherwise, if the access is granted, the fingerprint detection module is also switched back to the standby mode but does not return back to 702.

FIG. 7B presents a flowchart illustrating an exemplary process 701 of authenticating user request to access a locked mobile device in a high security mode based on a combination of fingerprint detection and optical heartbeat detection. The process 701 illustrated in FIG. 7B includes a fingerprint detection process which is substantially similar to the process 700 of FIG. 7A from (702) to (714). The full fingerprint sensor data obtained (714) is processed to verify whether the obtained fingerprint data match the stored fingerprint data of an authorized user of the locked mobile device (726). When no match is found, the user request to access the mobile device is denied and the fingerprint detection module is switched back to the standby mode (702). When a match is verified, the fingerprint detection module activates an optical detection module including the light emitting sources and the photodetectors to detect the presence of human heartbeat signals (728). Detecting the presence of human heartbeat signal can be performed with or without determining the actual heart beat rate. As described above, the two optical wavelengths emitted by the light emitting sources can be used to measure a user's heartbeat based on the oxygen level in the blood due to pumping of the heart. This heartbeat measurement offers an additional check on whether a live person is associated with the detected human fingerprint.

When the presence of a heartbeat signal is detected (730), the user request to access the locked mobile device is granted and the fingerprint detection module is switched back to a standby mode (732). Otherwise, the user request to access the locked mobile device is denied and the fingerprint detection module is switched back to the standby mode (702). Combining heartbeat detection with the fingerprint detection provides an added layer of security to the user authentication procedure.

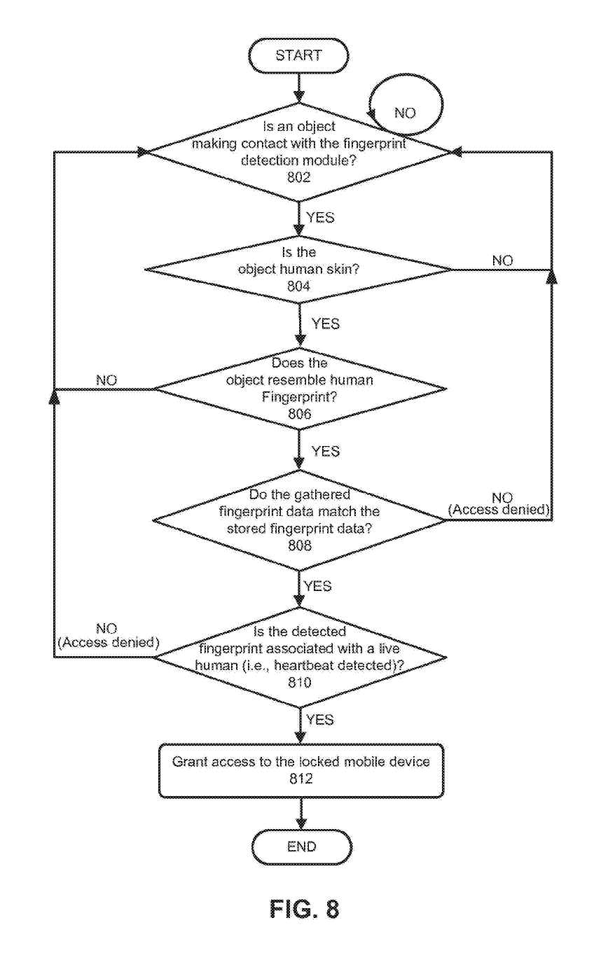

FIG. 8 presents a flowchart illustrating another exemplary process 800 of authenticating user request to access a locked mobile device in a high security mode based on a combination of fingerprint detection and optical heartbeat detection.

A fingerprint detection module in a standby mode can continuously monitors for a contact from an object with the fingerprint detection module (802). When the fingerprint detection module detects a contact from an object with the fingerprint detection module, the fingerprint detection module is used to determine whether the detected contact is from human skin (804). In absence of contact from human skin, the fingerprint detection module returns to standby mode and continues to monitor for another contact (802). When a contact from human skin is detected, the fingerprint detection module obtains data from the object making contact to determine whether the data from the object resembles human fingerprint (806). In absence of fingerprint detection, the fingerprint detection module returns to standby mode and continues to monitor for the next contact (802). When the detected contact is determined to be from human fingerprint, the main processing unit attempts to authenticate the obtained fingerprint data to determine whether the obtained fingerprint data match the stored fingerprint patterns of an authorized user of the mobile device (808). When the obtained fingerprint data does not match with the stored fingerprint pattern of the authorized user of the mobile device, the fingerprint detection module returns to standby mode and continues to monitor for the next contact (802). When the obtained fingerprint data match the stored fingerprint pattern of an authorized user of the mobile device, the fingerprint detection module determines whether the detected fingerprint of an authorized user of the mobile device is associated with a live human by detecting a presence of a heartbeat signal (810). When the presence of a heartbeat signal is detected, the user request to access the locked mobile device is granted. When the presence of a heartbeat is not detected, the user request to access the locked mobile device is denied and the fingerprint detection module returns to standby mode and continues to wait for the next contact (802). In various embodiments, the added verification of the heartbeat signal detection associated with the authorized user fingerprint detection at 810 can be implemented as an optional process and the user request to access the locked mobile device can be granted or denied based solely on the detection of an authorized user's fingerprint at 808. In some implementations, the user authentication process 800 can directly obtain fingerprint data from the object making contact without one or both intermediate processes of identifying the detected contact as being from human skin (804) and determining whether fingerprints can be found on the identified human skin (806). In some other implementations, the heartbeat detection process (810) may be performed after detecting a contact from an object (802) but before determining whether fingerprint data of an authorized user can be detected on the human skin making contact with the touch sensor of the fingerprint detector (808).

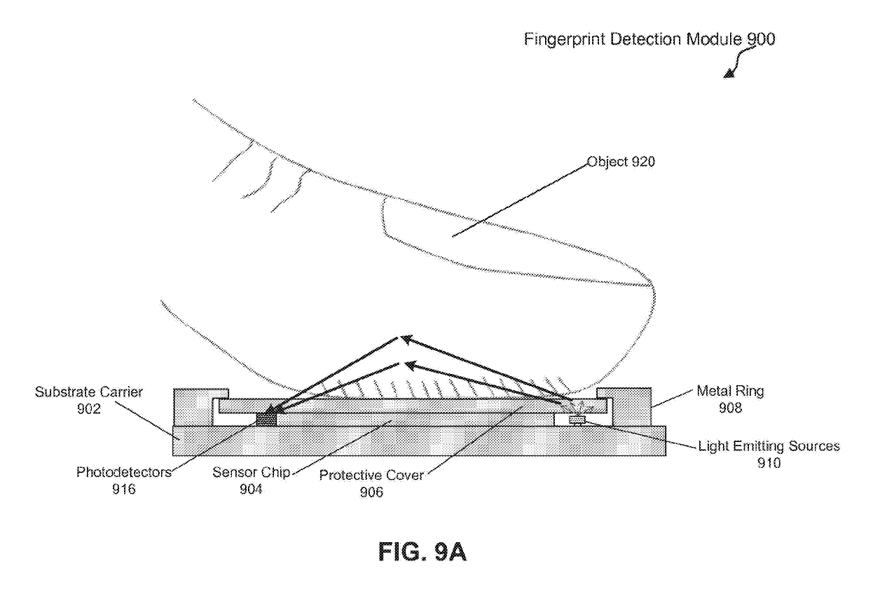

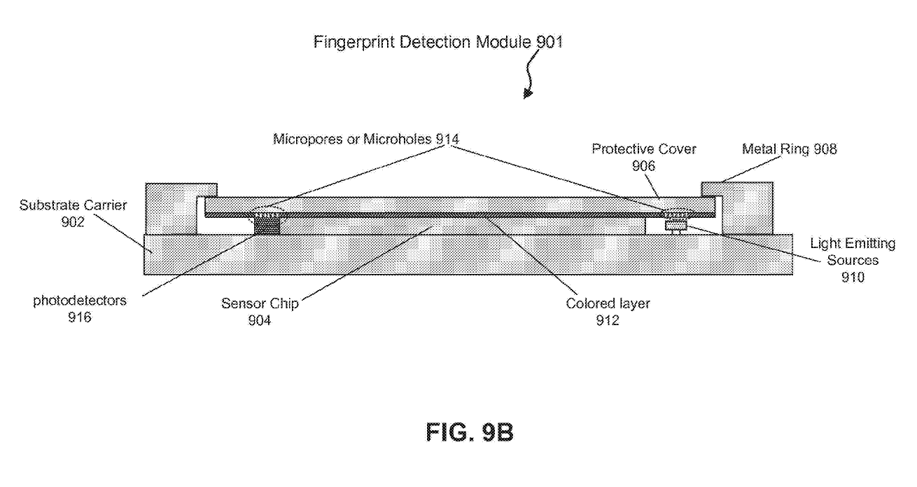

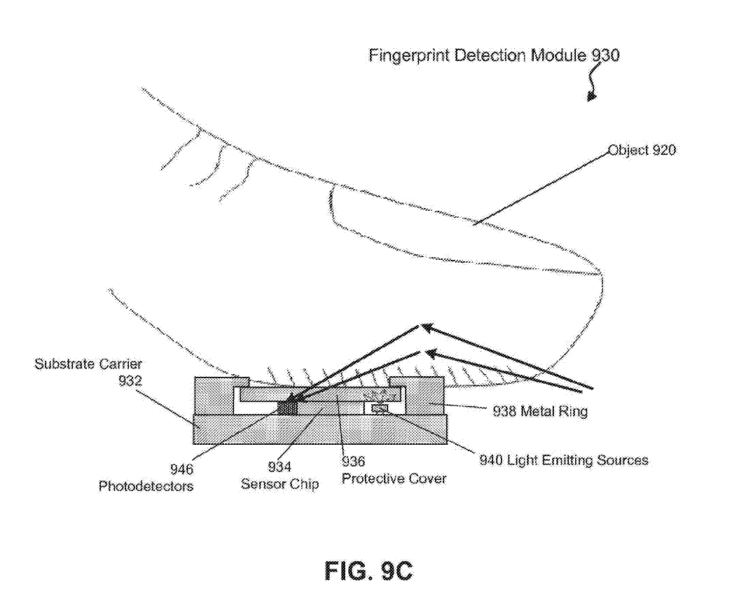

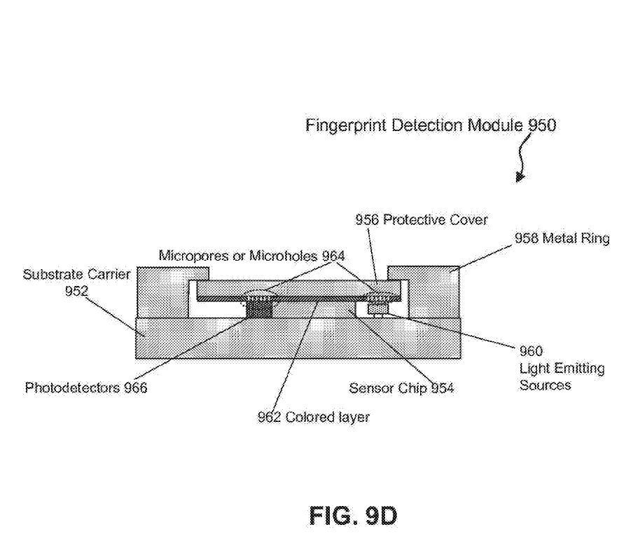

FIG. 9A illustrates an exemplary fingerprint detection module 900 as a variation of fingerprint detection module 400 for determining whether a detected contact from an object is from human skin in accordance with some embodiments described herein.

Similarly to fingerprint detection module 400, fingerprint detection module 900 includes substrate carrier 902, protective cover 906, touch sensor such as a metal ring 908 and sensor chip 904, which may include a capacitive sense array for sensing a fingerprint's ridge and valley patterns. Also, fingerprint detection module 900 includes one or more photodetectors 916 which can either be integrated on sensor chip 904 or separately placed on substrate carrier 902. The touch sensor for detecting a contact from an object can be implemented using conductive material having a shape corresponding to the fingerprint detection module, such as a metal ring 908 placed around and slightly above the protective cover to protect the border of the protective cover. The touch sensor can serve as a sensing electrode to detect a contact from an object 920 with the fingerprint detection module 900. In fingerprint detection module 900, one or more light emitting sources 910 are located directly under protective cover 906 within a gap between protective cover 906 and substrate carrier 902 and close to an edge of sensor chip 904. Thus, unlike the fingerprint detection module 400, the metal ring 908 in fingerprint detection module 900 does not include a cavity for housing the light emitting sources 910. In some implementations, light emitting sources 910 can emit at least two different wavelengths.

To allow detection light signals emitted from light emitting sources 910 to pass through protective cover 906 and reach object 920, the protective cover 906 is transparent to the detection lights. When protective cover 906 is coated with a colored layer on the bottom surface to achieve a desired appearance, the colored layer can be opaque to the wavelengths of lights emitted by light emitting sources 910, which are placed directly underneath the colored layer.

FIG. 9B illustrates an exemplary fingerprint detection module 901 which includes a protective cover coated with a colored layer in accordance with some embodiments described herein. As can be seen in FIG. 9B, fingerprint detection module 901 includes substrate carrier 902, sensor chip 904, protective cover 906, metal ring 908, one or more light emitting sources 910 located underneath protective cover 906, and one or more photodetectors 916. A colored layer 912 is coated on the bottom surface of protective cover 906 to provide the intended color appearance. The color layer 912 is transparent to the light emitted from light emitting sources 910 to allow the emitted light to pass through the colored layer 912 and reach an object making contact with protective cover 906. Moreover, the color layer 912 is transparent to reflected light from the object making contact with the protective cover 906 to reach photodetectors 916 which is also located underneath colored layer 912. In the embodiment shown in FIG. 9B, transparency to emitted light and reflected light is achieved using multiple micro-holes 914 created through colored layer 912 in the regions directly above light emitting sources 910 and photodetectors 916. These micro-holes 914 can be sufficiently small so that they are not visible to a user but large enough to allow emitted light from light emitting sources 910 to pass through and reach an object and reflected light from an object to pass though and reach photodetectors 916. For example, the size of the multiple micro-holes can be from about 1 μm to a few μm. In some implementations, micro-holes 914 are formed in the colored layer 912 using a laser.

In various embodiments of a fingerprint detection module described above (i.e., fingerprint detection modules 100, 300, 400, 900, and 901), the fingerprint sensor chip in a respective fingerprint detection module can have a thickness between 200 μm to 500 μm. The substrate in a respective fingerprint detection module can have a thickness between 0.5 mm to 2 mm. The metal ring in a respective fingerprint detection module can have a thickness between 0.5 mm to 2 mm. The thickness of the protective cover in a respective fingerprint detection module can be between 100 μm to 500 μm. The protective cover, e.g., protective cover 106, can be made of entirely by a single material, e.g., sapphire, zirconia, or ceramic. However, in some implementations, a protective cover can be made of at least two layers: a top layer of a relatively hard and more expensive material of high dielectric-constant (e.g., sapphire, zirconia, or diamond-like carbon) and a bottom layer of relatively less expensive material of high dielectric-constant (e.g., a ceramic material such as aluminum nitride (AlN)). For example, if a protective cover has an overall thickness of 450 μm, the top layer can be made of 150 μm of sapphire and the bottom layer can be made of 300 μm AlN. Such double layer structure can lower the overall cost of the protective cover while maintaining sufficiently high hardness and dielectric strength.

FIG. 9C illustrates an exemplary reduced size fingerprint detection module 930 as a variation on the fingerprint detection module 430 for determining whether an image captured of an object making contact with the reduced size fingerprint detection module 930 matches a registered finger print of an authorized user. The reduced size fingerprint detection module 930 is substantially similar to fingerprint detection module 900 except for the smaller size and a differing shape (e.g., shaped in a strip).

Similarly to fingerprint detection module 430, fingerprint detection module 930 includes substrate carrier 932, protective cover 936, touch sensor or sensing electrode such as a metal ring 938 and a reduced size sensor chip 934, which may include a capacitive sense array for sensing a fingerprint's ridge and valley patterns. Also, fingerprint detection module 930 includes one or more photodetectors 946 which can either be integrated on sensor chip 934 or separately placed on substrate carrier 932. The touch sensor for detecting a contact from an object can be implemented using conductive material having a shape corresponding to the fingerprint detection module, such as a metal ring 938 placed around and slightly above the protective cover to protect the border of the protective cover. The touch sensor can serve as a sensing electrode to detect a contact from an object 920 with the fingerprint detection module 930. In fingerprint detection module 930, one or more light emitting sources 940 are located directly under protective cover 936 within a gap between protective cover 936 and substrate carrier 932 and close to an edge of sensor chip 934. Thus, unlike the fingerprint detection module 430, the metal ring 938 in fingerprint detection module 930 does not include a cavity for housing the light emitting sources 940. In some implementations, light emitting sources 940 can emit at least two different wavelengths.

To allow detection light signals emitted from light emitting sources 940 to pass through protective cover 936 and reach object 920, the protective cover 936 is transparent to the detection lights. When protective cover 936 is coated with a colored layer on the bottom surface to achieve a desired appearance, the colored layer can be opaque to the wavelengths of lights emitted by light emitting sources 940, which are placed directly underneath the colored layer.

FIG. 9D illustrates an exemplary reduced size fingerprint detection module 950 which includes a protective cover 956 coated with a colored layer 962. As can be seen in FIG. 9D, reduced size fingerprint detection module 950 includes substrate carrier 952, reduced size sensor chip 954, protective cover 956, touch sensor or sensing electrode such as metal ring 958, one or more light emitting sources 960 located underneath protective cover 956, and one or more photodetectors 966. A colored layer 962 is coated on the bottom surface of protective cover 956 to provide the intended color appearance. The color layer 962 is transparent to the light emitted from light emitting sources 960 to allow the emitted light to pass through the colored layer 962 and reach an object making contact with protective cover 956. Moreover, the color layer 962 is transparent to reflected light from the object making contact with the protective cover 956 to reach photodetectors 966 which is also located underneath colored layer 962. In the embodiment shown in FIG. 9D, transparency to emitted light and reflected light is achieved using multiple micro-holes 964 created through colored layer 962 in the regions directly above light emitting sources 960 and photodetectors 966. These micro-holes 964 can be sufficiently small so that they are not visible to a user but large enough to allow emitted light from light emitting sources 960 to pass through and reach an object and reflected light from an object to pass though and reach photodetectors 966. For example, the size of the multiple micro-holes can be from about 1 μm to a few μm. In some implementations, micro-holes 914 are formed in the colored layer 962 using a laser.

In various embodiments of a reduced size fingerprint detection module described above(i.e., fingerprint detection modules 120, 320, 430, 930, and 950), a reduced size fingerprint sensor chip in a respective reduced size fingerprint detection module can have a thickness between 200 μm to 500 μm. The substrate in a respective fingerprint detection module can have a thickness between 0.5 mm to 2 mm. The metal ring in a respective fingerprint detection module can have a thickness between 0.5 mm to 2 mm. The thickness of the protective cover in a respective fingerprint detection module can be between 100 μm to 500 μm. The protective cover, e.g., protective cover 956, can be made of entirely by a single material, e.g., sapphire, zirconia, or ceramic. However, in some implementations, a protective cover 956 can be made of at least two layers: a top layer of a relatively hard and more expensive material of high dielectric-constant (e.g., sapphire, zirconia, or diamond-like carbon) and a bottom layer of relatively less expensive material of high dielectric-constant (e.g., a ceramic material such as aluminum nitride (AlN)). For example, if a protective cover has an overall thickness of 450 μm, the top layer can be made of 150 μm of sapphire and the bottom layer can be made of 300 μm AlN. Such double layer structure can lower the overall cost of the protective cover while maintaining sufficiently high hardness and dielectric strength.

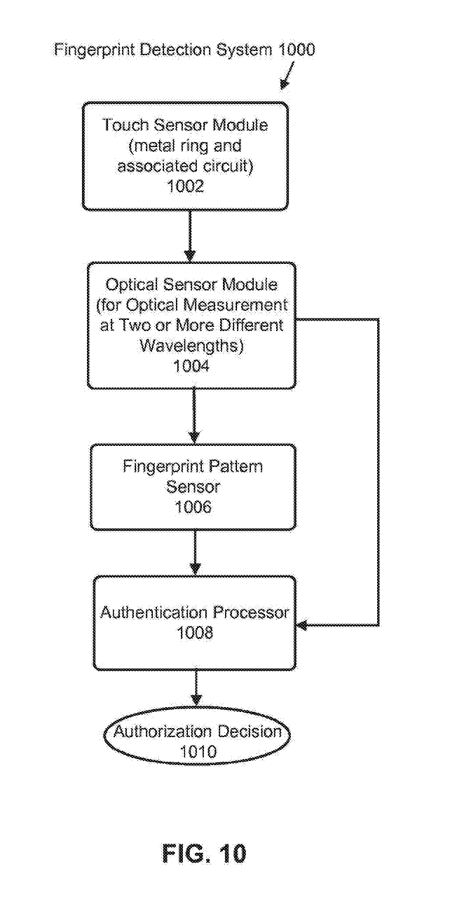

FIG. 10 presents a diagram of an exemplary fingerprint detection system 1000 for performing human fingerprint detection and authentication in accordance with some embodiments described herein. As shown in FIG. 10, fingerprint detection system 1000 includes a touch sensing module 1002 which includes a touch sensor (such as a metal ring) and sensor circuitry for detecting a contact from an object with fingerprint detection system 1000. Also, fingerprint detection system 1000 includes an optical sensor module 1004, a fingerprint pattern sensor 1006, and an authentication processor 1008. Touch sensing module 1002 is communicatively coupled to optical sensor module 1004 to combine sensor data from touch and optical sensors. When touch sensing module 1002 detects a contact from an object, such as a finger, touch sensing module 1002 activates optical sensor module 1004 to perform fingerprint analysis. Optical sensor module 1004 produces probe light at two or more different optical wavelengths to which a person's skin produces different optical responses at the two or more different optical wavelengths due to presence of blood in the person's skin. An optical detection unit in the optical sensor module 1004 receives a reflection or transmission of the probe light from the object making contact to detect optical measurements that represent reactions of the reflected probe light at the two or more different optical wavelengths. The optical measurements of the reflected probe at different wavelengths can be used to compute values that are compared to standard or calibrated values for human blood absorption to determine whether the detected contact is from human skin. The computation, comparison, and determination of reflected probe light operations can be performed by an on-chip signal processing unit integrated with optical sensor module 1004.

Optical sensor module 1004 is communicatively coupled to fingerprint pattern sensor 1006. When optical sensor module 1004 detects human skin as the object making contact, optical sensor module 1004 activates fingerprint pattern sensor 1006. Fingerprint pattern sensor 1006 includes a sensor array which obtains fingerprint data and a fingerprint pattern processor that determines whether the obtained fingerprint data resembles a human fingerprint. Fingerprint pattern sensor 1006 is communicatively coupled to authentication processor 1008. When fingerprint pattern sensor 1006 detects a human fingerprint, fingerprint pattern sensor 1006 activates authentication processor 1008. Authentication processor 1008 receives the obtained fingerprint data from fingerprint pattern sensor 1006 and verifies whether the obtained fingerprint data matches stored fingerprint data of an authorized person's fingerprint pattern. Based on the verification outcome, the authentication processor generates authorization decision 1010 to determine whether the user request to access the locked mobile device is granted or denied.

In a high security operation mode, authentication processor 1008 can receive optical measurements at two or more optical wavelengths from optical sensor module 1004, and used the optical measurements to detect a presence of a human heartbeat signal. This heartbeat detection offers an additional layer of security on whether a live person is associated with the detected human fingerprint. The authentication processor 1008 then generates authorization decision 1010 based on both the result of fingerprint authentication and the result of heartbeat detection.

Techniques, systems, and devices are disclosed for performing human fingerprint detection and authentication using an optical detection module in addition to a fingerprint pattern recognition sensor. The disclosed human fingerprint detection and authentication technology can be integrated with mobile devices (e.g., smartphones and tablets) and other devices (e.g., such as computer monitors) to improve the fingerprint authentication technology used in existing devices.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method for registering and recognizing a fingerprint profile on a mobile device, the method comprising:
operating in a fingerprint registration mode, including:
detecting, at a fingerprint detection module having a non-uniform shape, a contact from a finger associated with a swipe motion,
responsive to the detected contact at the fingerprint detection module having the non-uniform shape, capturing an image of the finger during the swipe motion, and
storing the image of the finger captured during the swipe motion as a registered fingerprint profile of an authorized user; and
operating in a fingerprint recognition mode, including:
detecting a non-swipe contact from a finger of a user on the non-uniformly shaped fingerprint detection module of the mobile device while the mobile device is locked,
responsive to detecting the non-swipe contact, activating the non-uniformly shaped fingerprint detection module to capture a partial image of the finger making the non-swipe contact with the non-uniformly shaped fingerprint detection module, and
comparing the captured partial image of the finger making contact with the non-uniformly shaped fingerprint detection module with the registered fingerprint profile of the authorized user of the mobile device, and
responsive to the comparing, identifying the captured partial image as belonging to the authorized user and granting the user access to the locked mobile device.

2. The method of claim 1, comprising:
receiving a signal indicating the fingerprint registration mode; and
responsive to receiving the signal indicating the fingerprint registration mode, activating the fingerprint detection module to operate in the fingerprint registration mode.

3. The method of claim 1, wherein capturing an image of the finger during the swipe motion includes:
capturing partial images of the finger in sequence during the swipe motion to accumulate a substantially complete fingerprint image to store as the registered fingerprint profile of an authorized user.

4. The method of claim 1, wherein capturing an image of the finger during the swipe motion includes:
detecting differences between three lines of pixilated sensing elements of the non-uniformly shaped fingerprint detector module.

5. The method of claim 1, comprising:
analyzing the partial images of the finger captured during the swipe motion to determine whether a sufficient portion of the finger was captured to qualify as the registered fingerprint profile of an authorized user.

6. The method of claim 1 comprising:
outputting a message to instruct a user to swipe a finger across the non-uniformly shaped fingerprint detection module.

7. The method of claim 1, wherein the message includes at least one of audio, texts, images or videos.

8. The method of claim 1, wherein the comparing includes:
correlating the captured image of the finger with the registered fingerprint profile of an authorized user.

9. The method of claim 8, wherein the identifying includes:
when a correlation between the captured image of the finger and the registered fingerprint profile of an authorized user is statistically significant, identifying the captured image of the finger as bellowing to the authorized user.

10. The method of claim 8, wherein the non-uniformly shaped fingerprint detection module includes a rectangular shaped fingerprint detection module with a first number of sensor pixels in one dimension and a second number of sensing electrodes larger than the first number in another dimension.

11. The method of claim 1, comprising:
receiving a signal indicating the fingerprint recognition mode; and
responsive to receiving the signal indicating the fingerprint recognition mode, activating the fingerprint detection module to operate in the fingerprint recognition mode.

12. A mobile device comprising:
a transparent top cover;
a touch panel configured to receive touch input, the touch panel disposed under the transparent top cover; and
a non-uniformly shaped fingerprint detection module configured to operate in a fingerprint registration mode to detect a swipe motion contact and a fingerprint recognition mode to detect a non-swipe motion contact, wherein:
during the fingerprint registration mode, the non-uniformly shaped fingerprint detection module is configured to:
detect a contact from a finger associated with a swipe motion,
responsive to the detected swipe motion contact, capturing an image of the finger, and
store the image of the finger captured during the swipe motion as a registered fingerprint profile of an authorized user; and
during the fingerprint recognition mode, the non-uniformly shaped fingerprint detection module is configured to:
detect a non-swipe contact from a finger of a user while the mobile device is locked,
responsive to the detected non-swipe contact, activate the non-uniformly shaped fingerprint detection module to capture a partial image of the finger making the non-swipe contact with the non-uniformly shaped fingerprint detection module, and
compare the captured partial image of the finger making contact with the non-uniformly shaped fingerprint detection module with the registered fingerprint profile of the authorized user of the mobile device, and
identify the captured partial image as belonging to the authorized user and granting the user access to the locked mobile device.

13. The mobile device of claim 12, wherein the non-uniformly shaped fingerprint detection module is embedded in the transparent top cover to expose a top surface of the non-uniformly shaped fingerprint detection module to make direct contact with the finger of a user.

14. The mobile device of claim 12, wherein the non-uniformly shaped fingerprint detection module includes a rectangular shaped fingerprint detection module with a first number of sensor pixels in one dimension and a second number of sensing electrodes larger than the first number in another dimension.

15. The mobile device of claim 12, comprising a protective cover disposed over the transparent top cover, the touch panel and the non-uniformly shaped fingerprint detection module to prevent direct contact between the finger of the user and the non-uniformly shaped fingerprint detection module.

16. The mobile device of claim 12, wherein the non-uniformly shaped fingerprint detection module includes:
fingerprint sensing circuitry; and
an array of sensing electrodes to detect the contact from the finger of the user to activate the non-uniformly shaped fingerprint detection module to capture the image of the finger of the user.

17. The mobile device of claim 16, wherein the sensing circuitry includes more columns of pixelated sensing elements than rows of pixelated sensing elements.

18. The mobile device of claim 12, wherein the non-uniformly shaped fingerprint detection module is configured to receive a signal indicating the fingerprint registration mode.

19. The mobile device of claim 12, wherein the non-uniformly shaped fingerprint module is configured to capture the image of the finger during the swipe motion by capturing partial images of the finger in sequence during the swipe motion to accumulate a substantially complete fingerprint image to store as the registered fingerprint profile of an authorized user.

20. The mobile device of claim 19, wherein the non-uniformly shaped fingerprint module is configured to analyze the partial images of the finger captured during the swipe motion to determine whether a sufficient portion of the finger was captured to qualify as the registered fingerprint profile of an authorized user.
